(19) United States
(12) Patent Application Publication
(10) Pub. No.: US 2026/0172126 A1
(43) Pub. Date: Jun. 18, 2026

(54) Communication Device Testing Method, Terminal, and Network Side Device

(71) Applicant: VIVO MOBILE COMMUNICATION CO., LTD., Dongguan (CN)

(72) Inventors: Zhanyuan Wang, Dongguan (CN); Minhua Zheng, Dongguan (CN); Qian Yang, Dongguan (CN)

(21) Appl. No.: 19/532,090

(22) Filed: Feb. 6, 2026

Related U.S. Application Data
(63) Continuation of application No. PCT/CN2024/110424, filed on Aug. 7, 2024.

(30) Foreign Application Priority Data
Aug. 10, 2023 (CN) 202311009567.0

(51) Int. Cl. H04B 17/29; H04B 17/00; H04B 17/391

(52) U.S. Cl. CPC H04B 17/294; H04B 17/0085; H04B 17/3913

(57) ABSTRACT

A communication device test method includes receiving, by a DUT, a first signal sent by TE, where the first signal is a signal corresponding to a first test case; and processing, by the DUT, the first signal, and sending a second signal to the TE, where the second signal includes at least one of the following: a signal obtained by processing the first signal by using a reference model with an AI functionality, a signal obtained by performing non-AI functionality processing on the first signal, or a signal obtained by processing the first signal by using an AI model; and the second signal is used to obtain a test result corresponding to the first test case.

### CROSS-REFERENCE TO RELATED APPLICATIONS

This application is a Bypass Continuation Application of International Patent Application No. PCT/CN2024/110424 filed Aug. 7, 2024, and claims priority to Chinese Patent Application No. 202311009567.0 filed Aug. 10, 2023, the disclosures of which are hereby incorporated by reference in their entireties.

### BACKGROUND OF THE INVENTION

### Field of the Invention

This application pertains to the field of communication technologies, and in particular, relates to a communication device test method, a terminal, and a network side device.

### Description of Related Art

In research and development, production, and acceptance processes of mobile communication devices, a test technology permeates throughout as an indispensable part. Relevant mobile communication test procedures are formulated based on a conventional communication technology. For example, a channel scenario and a channel modeling procedure are defined based on a conventional mobile communication architecture to test a communication device, and each test phase corresponds to an explicit physical meaning.

### SUMMARY OF THE INVENTION

According to a first aspect, a communication device test method is provided. The method includes: receiving, by a device under test (DUT), a first signal sent by test equipment (TE), where the first signal is a signal corresponding to a first test case; and processing, by the DUT, the first signal, and sending a second signal to the TE. The second signal includes at least one of the following: a signal obtained by processing the first signal by using a reference model with an AI functionality, a signal obtained by performing non-AI functionality processing on the first signal, or a signal obtained by processing the first signal by using an AI model. The second signal is used to obtain a test result corresponding to the first test case.

According to a second aspect, a communication device test method is provided. The method includes: sending, by TE, a first signal to a DUT, where the first signal is a signal corresponding to a first test case; and receiving, by the TE, a second signal sent by the DUT, and processing the second signal to obtain a test result corresponding to the first test case. The second signal includes at least one of the following: a signal obtained by processing the first signal by using a reference model with an AI functionality, a signal obtained by performing non-AI functionality processing on the first signal, or a signal obtained by processing the first signal by using an AI model.

According to a third aspect, a communication device test apparatus is provided. The apparatus includes a receiving module, a processing module, and a sending module. The receiving module is configured to receive a first signal sent by TE, where the first signal is a signal corresponding to a first test case. The processing module is configured to process the first signal. The sending module is configured to send a second signal to the TE. The second signal includes at least one of the following: a signal obtained by processing the first signal by using a reference model with an AI functionality, a signal obtained by performing non-AI functionality processing on the first signal, or a signal obtained by processing the first signal by using an AI model. The second signal is used to obtain a test result corresponding to the first test case.

According to a fourth aspect, a communication device test apparatus is provided. The apparatus includes a sending module, a receiving module, and a processing module. The sending module is configured to send a first signal to a DUT, where the first signal is a signal corresponding to a first test case. The receiving module is configured to receive a second signal sent by the DUT. The processing module is configured to process the second signal to obtain a test result corresponding to the first test case. The second signal includes at least one of the following: a signal obtained by processing the first signal by using a reference model with an AI functionality, a signal obtained by performing non-AI functionality processing on the first signal, or a signal obtained by processing the first signal by using an AI model.

According to a fifth aspect, a terminal is provided. The terminal includes a processor and a memory, the memory stores a program or an instruction executable on the processor, and when the program or the instruction is executed by the processor, the steps of the method according to the first aspect or the steps of the method according to the second aspect are implemented.

According to a sixth aspect, a terminal is provided, including a processor and a communication interface. The communication interface is configured to receive a first signal sent by TE, where the first signal is a signal corresponding to a first test case; the processor is configured to process the first signal; and the communication interface is further configured to send a second signal to the TE. The second signal includes at least one of the following: a signal obtained by processing the first signal by using a reference model with an AI functionality, a signal obtained by performing non-AI functionality processing on the first signal, or a signal obtained by processing the first signal by using an AI model. The second signal is used to obtain a test result corresponding to the first test case. Alternatively, the communication interface is configured to: send a first signal to a DUT, and receive a second signal sent by the DUT; and the processor is configured to process the second signal to obtain a test result corresponding to a first test case. The first signal is a signal corresponding to the first test case, and the second signal includes at least one of the following: a signal obtained by processing the first signal by using a reference model with an AI functionality, a signal obtained by performing non-AI functionality processing on the first signal, or a signal obtained by processing the first signal by using an AI model.

According to a seventh aspect, a network side device is provided. The network side device includes a processor and a memory, the memory stores a program or an instruction executable on the processor, and when the program or the instruction is executed by the processor, the steps of the method according to the first aspect or the steps of the method according to the second aspect are implemented.

According to an eighth aspect, a network side device is provided, including a processor and a communication interface. The communication interface is configured to receive a first signal sent by TE, where the first signal is a signal corresponding to a first test case; the processor is configured to process the first signal; and the communication interface is further configured to send a second signal to the TE. The second signal includes at least one of the following: a signal obtained by processing the first signal by using a reference model with an AI functionality, a signal obtained by performing non-AI functionality processing on the first signal, or a signal obtained by processing the first signal by using an AI model. The second signal is used to obtain a test result corresponding to the first test case. Alternatively, the communication interface is configured to: send a first signal to a DUT, and receive a second signal sent by the DUT; and the processor is configured to process the second signal to obtain a test result corresponding to a first test case. The first signal is a signal corresponding to the first test case, and the second signal includes at least one of the following: a signal obtained by processing the first signal by using a reference model with an AI functionality, a signal obtained by performing non-AI functionality processing on the first signal, or a signal obtained by processing the first signal by using an AI model.

According to a ninth aspect, a non-transitory readable storage medium is provided. The non-transitory readable storage medium stores a program or an instruction, and when the program or the instruction is executed by a processor, the steps of the method according to the first aspect or the steps of the method according to the second aspect are implemented.

According to a tenth aspect, a wireless communication system is provided, including a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a non-transitory storage medium, and the program/program product is executed by at least one processor to implement the steps of the communication device test method according to the first aspect or the steps of the communication device test method according to the second aspect.

### BRIEF DESCRIPTION OF THE DRAWINGS

FIG. 1 is a possible schematic architecture diagram of a communication system according to an embodiment of this application;

FIG. 2 is a schematic diagram of a neuron according to an embodiment of this application;

FIG. 3 is a schematic flowchart of a communication device test method according to an embodiment of this application;

FIG. 4 is a first schematic structural diagram of a communication device test apparatus according to an embodiment of this application;

FIG. 5 is a second schematic structural diagram of a communication device test apparatus according to an embodiment of this application;

FIG. 6 is a schematic structural diagram of a communication device according to an embodiment of this application;

FIG. 7 is a schematic structural diagram of hardware of a terminal according to an embodiment of this application; and

FIG. 8 is a schematic structural diagram of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, “or” in this application means at least one of connected objects. For example, “A or B” covers three schemes. Scheme 1: including A but excluding B; Scheme 2: including B but excluding A; Scheme 3: including both A and B. The character “/” generally indicates an “or” relationship between the associated objects.

The term “indication” in this application may be either a direct indication (or an explicit indication) or an indirect indication (or an implicit indication). A direct indication may be understood as that a sender explicitly informs a recipient of content such as information, an operation to be performed, or a requested result in a sent indication. An indirect indication may be understood as that a recipient determines corresponding information based on an indication sent by a sender, or makes a judgment and determines an operation to be performed or a requested result based on a judgment result.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), or other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to systems other than the NR system, such as a 6-th generation (6G) communication system.

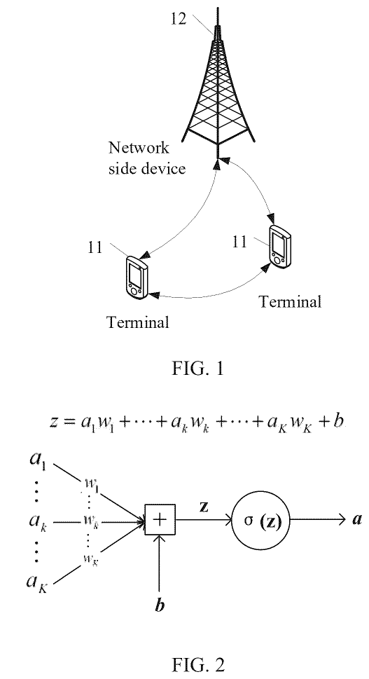

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), shipborne equipment, pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. The vehicle user equipment may also be referred to as an in-vehicle terminal, an in-vehicle controller, an in-vehicle module, an in-vehicle component, an in-vehicle chip, or an in-vehicle unit. It should be noted that a type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (WiFi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. As long as a same technical effect is achieved, the base station is not limited to a specified technical term. It should be noted that, in this application, only a base station in an NR system is used as an example, and a type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rule function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that, in the embodiments of this application, only a core network device in an NR system is used as an example for description, and a type of the core network device is not limited.

The following describes some concepts or terms in the communication device test method provided in the embodiments of this application.

### 1. Artificial Intelligence (AI)

Artificial intelligence (AI) has now been widely applied to various fields. Integrating artificial intelligence into wireless communication networks to significantly enhance technical metrics such as a throughput, a delay, and a user capacity is an important task for future wireless communication networks. An AI module has a plurality of implementations, such as a neural network, a decision tree, a support vector machine, and a Bayes classifier. In this application, the neural network is used as an example for description, but a type of the AI module is not limited.

A neural network typically includes an input layer, a hidden layer, and an output layer. A neuron, also referred to as a node or a unit, is a basic computing unit of the neural network. A schematic diagram of the neuron is shown in FIG. 2, where a₁, a₂,..., a_{K} are inputs, w is a weight (that is, a multiplicative coefficient), b is a bias (that is, an additive coefficient), and σ(.) is an activation function. Common activation functions include an S-type growth curve (Sigmoid function), a hyperbolic tangent function (tanh function), a rectified linear function (that is, a rectified linear unit (ReLU)), and the like.

Parameters of the neural network are optimized by using a gradient optimization algorithm. The gradient optimization algorithm is an algorithm for minimizing or maximizing an objective function (sometimes called a loss function). The objective function is often a mathematical combination of a model parameter and data. For example, data x and a corresponding label Y are given, and a neural network model f(.) is constructed. Then, a predicted output f(x) may be obtained based on the input x, and a difference (f(x)−Y) between a predicted value and a real value may be calculated. This is the loss function. The objective of optimization is to find proper w and b to minimize a value of the above loss function. If the value of the loss function is smaller, the model is closer to a real situation.

Currently, common optimization algorithms are basically based on an error back propagation (BP) algorithm. A basic idea of the BP algorithm is that a learning process includes two processes: signal forward propagation and error back propagation. During forward propagation, an input sample is transferred from an input layer to an output layer after being processed by each hidden layer. If an actual output of the output layer does not match an expected output, error back propagation is performed. Error back propagation is to transmit an output error backward to the input layer through the hidden layer in some form, and allocate the error to all units of each layer, to obtain an error signal of a unit at each layer. This error signal is used as a basis for rectifying a weight of each unit. A weight adjustment process of each layer during signal forward propagation and error back propagation is carried out repeatedly. A process of continuously adjusting a weight is a learning and training process of a network. This process continues until errors output by the network are reduced to an acceptable level or until a preset quantity of learning times are reached.

The common optimization algorithms include gradient descent, stochastic gradient descent (SGD), mini-batch gradient descent, momentum, stochastic gradient descent with momentum (Nesterov, a name of the inventor), adaptive gradient descent (Adagrad), an Adadelta algorithm, root mean square prop (RMSProp), adaptive moment estimation (Adam), and the like. During error back propagation, in these optimization algorithms, an error or a loss is obtained based on the loss function, a gradient is obtained by calculating a derivative or a partial derivative of a current neuron and adding a learning rate and a previous gradient, derivative, or partial derivative, and the gradient is transferred to an upper layer.

### 2. AI Model

The AI model may also be referred to as an AI unit, an ML model, an ML unit, an AI structure, an AI functionality, an AI feature, a neural network, a neural network function, a neural network functionality, or the like. Alternatively, the AI model may be a processing unit capable of implementing an AI-related specific algorithm, formula, processing procedure, capability, or the like. Alternatively, the AI model may be a processing method, an algorithm, a functionality, a module, or a unit for a specific dataset. Alternatively, the AI model may be a processing method, an algorithm, a functionality, a module, or a unit that runs on AI- or ML-related hardware such as a graphics processing unit (GPU), a neural-network processing unit (NPU), a tensor processing unit (TPU), or an application specific integrated circuit (ASIC). The foregoing specific dataset may include an input and an output of the AI model.

An identifier of the AI model may be an AI model identifier, an AI structure identifier, an AI algorithm identifier, or an identifier of a specific dataset associated with the AI model, or may be an identifier of an AI- or ML-related specific scenario, environment, channel feature, or device, or may be an identifier of an AI-or ML-related functionality, feature, capability, or module.

The AI model is determined by a model structure and a model parameter. The model structure generally includes a model input layer, a model output layer, a model structure backbone, and a connection layer among the three. Commonly used model structure backbones include a convolutional neural network (CNN), a fully connected structure, and a transformer. The model parameter includes parameters such as a weight and a bias of each layer in the model structure.

### 3. Mobile Communication Test

In research and development, production, and acceptance processes of mobile communication devices, a test technology permeates throughout as an indispensable part. Test objects include communication devices such as a base station, a terminal device, and a chip. The test of the mobile communication device may be divided into a certification test, a research and development test, and a production test based on different lifecycles or different test objectives. The certification test needs to be performed by an organization that has a certification qualification. Typically, test specifications are based on test cases (use cases) and minimum requirements specified by organizations such as the 3rd generation partnership project (3GPP), the cellular telecommunications industry association (CTIA), and the global certification forum (GCF). This type of test imposes stringent requirements on an environment, a device, and a pass standard, with a primary focus on conformance testing. The research and development test focuses on whether some issues arise in a research and development process of the product, and does not necessarily need to be verified based on a test case standardized in the specification. The production test is an automated test conducted during mass production of the product, which focuses more on test efficiency. Therefore, for the wireless communication device, a test system often has high costs, a complex test system, and a stringent test pass requirement and a test case. Developing a standardized test procedure that complies with the specification is also one of goals currently pursued by many standards organizations.

Currently, 3GPP's test specifications for a radio frequency conducted test, an over-the-air (OTA) test, and a corresponding performance test focus on metrics including radio frequency metrics such as a total radiated power, an equivalent isotropic sensitivity (EIS), an error vector magnitude (EVM), an adjacent channel leakage ratio (ACLR), and a throughput. 3GPP also formulates standards specifications for a baseband-related radio resource management (RRM) test and a demodulation test. In addition, for different test cases, 3GPP specifies many RRM metrics to be tested (see TS 38.133). For example, for a test case of positioning, 3GPP specifies that user equipment (UE) needs to pass the test case under a specified condition and meet a specified minimum time requirement of a reference signal time difference (RSTD) or a receive-transmit time difference (Rx-Tx time difference) and a minimum power requirement of a reference signal received power (RSRP) or a reference signal received path power (RSRPP). For a test case of beam prediction, 3GPP specifies an RRM measurement requirement of a layer 1 reference signal received power (L1-RSRP) and a baseband demodulation performance requirement of a device (see TS 38.101-4). For a test case of channel state information (CSI) reporting, 3GPP specifies requirements for reporting a channel quality indication (CQI), a precoding matrix indicator (PMI), and a rank indication (RI) under a specified test condition. In an entire communication procedure, a baseband test needs to meet a corresponding core requirement such as an interruption or a delay.

AI or ML test objectives primarily fall into the following categories: testing an AI-enabled device performance metric; testing a life cycle management (LCM) core requirement; and measuring an LCM functionality. For the device performance metric, the test primarily focuses on an inference result of an AI model or an ML model. Different test cases generally correspond to different performance metrics. By testing whether the performance metric meets a pass or fail criteria, for example, a requirement specified by a radio access network work group 4 (RAN WG4, also known as RAN4), it is determined whether the AI model or the ML model can achieve a desired effect. For the LCM core requirement, it is generally considered that test metrics include a delay and an interruption. A test result is judged by determining whether the delay and the interruption to be tested in an LCM procedure meet the defined requirement. For the measurement of the LCM functionality, it is generally determined whether a corresponding functionality in LCM is enabled and whether a corresponding effect is achieved. Within a capability range supported by a DUT, if an LCM functionality required to be enabled in the test is either not enabled or fail to achieve the corresponding effect in the test procedure, the LCM functionality is determined to be faulty.

With reference to the accompanying drawings, the following describes in detail the communication device test method provided in the embodiments of this application by using some embodiments and application scenarios thereof.

Relevant mobile communication test procedures are formulated based on a conventional communication technology. Each test phase corresponds to an explicit physical meaning. However, for an AI/ML model-based communication system, because most AI/ML models lack an explicit physical meaning, the AI/ML models are opaque black boxes for a tester, and therefore, a conventional test technology cannot be directly applied to the AI/ML model-based communication system. Therefore, how to test the AI/ML model-based communication device becomes an urgent problem to be resolved.

Generally, for the AI/ML model-based communication system, an AI model may be deployed on a single device side or may be deployed on two sides. For example, AI models are deployed on both a user equipment side and a base station side. For a 2-sided model framework, AI models need to be separately deployed on a device under test side and a test equipment side, and model structures on both sides need to match each other. If the model structures on both sides do not match, performance degradation or even system failure may occur. In addition, for a 1-sided model framework, AI models provided by manufacturers are diversified, and a unified performance requirement cannot be defined.

In addition, AI is a data-based technology, and model training, model inference, and model monitoring are all performed based on data. In a mobile communication technology, a wireless device may be located in diverse environments, such as a shopping mall in a city, a vehicle, a stadium, a high-speed train, or an open rural area. To simulate these diverse wireless scenarios, many standards organizations define different channel scenarios and channel modeling procedures for device testing. These channel models are defined based on a conventional mobile communication architecture. For example, a cluster, a multipath, an angle of departure, an angle of arrival, a power, a delay, and the like constitute a channel model with an explicit physical meaning. Therefore, if a wireless device passes the test in a scenario of the defined channel model, there is similar performance when being deployed in a real field environment. However, an AI model often lacks an explicit physical meaning, and the AI model only generates a weight coefficient of each node of a neural network from a dataset (which may be a channel coefficient matrix, a channel impact response, or the like) provided based on a channel model, resulting in robustness degradation in different channel environments, that is, a sensitivity to a channel environment change is greatly increased and the channel environment change may significantly impact an AI communication system. In other words, if the foregoing channel model is used as a dataset of the model, the device may pass the test in the test system, but performance degradation or even system failure may occur after being deployed in the field.

To resolve the foregoing problem, a reference model is introduced in the embodiments of this application. For different test cases, the reference model may be implemented differently. For example, when a test case is CSI compression and prediction, a 2-sided model framework is used, and the reference model may be implemented as a reference encoder/decoder. When a device under test is UE, a reference decoder is deployed on a test equipment side, and an AI encoder is deployed on the UE side. When a device under test is a gNB, a reference encoder is deployed on a test equipment side, and an AI decoder is deployed on the gNB side. Considering model matching in the test system and model matching in actual deployment, the embodiments of this application provide a predefining manner of the reference model and an implementation of the reference model in the test process. For example, the introduction of the reference model provides a unified reference for manufacturers, thereby effectively resolving the problem that the unified performance requirement cannot be defined.

In addition, a test method and a test dataset should have generalization performance. Therefore, in the embodiments of this application, all wireless scenarios or configurations supported within a device capability range are specified, thereby ensuring that the test can cover as many channel scenarios as possible that likely to appear in the field, and avoiding situations that the device struggles to operate in the field or experiences significant performance degradation even after passing the test.

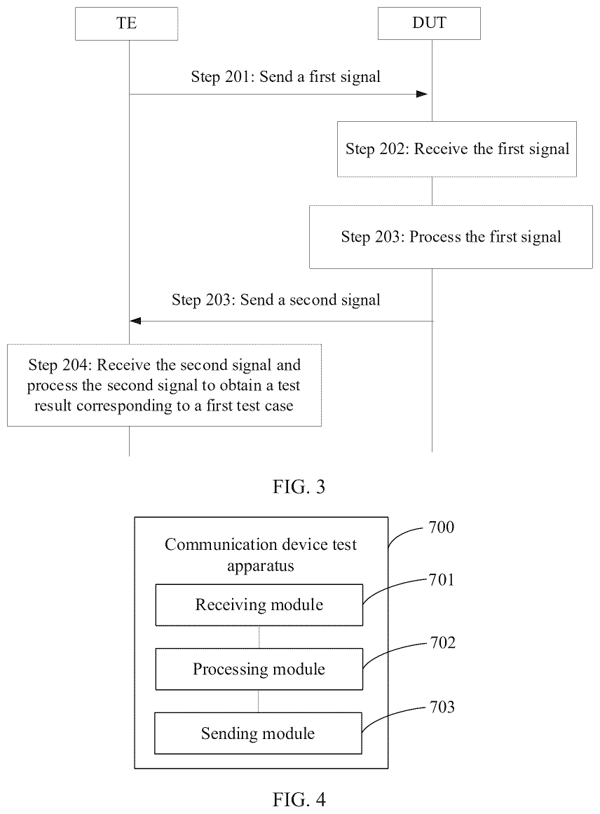

An embodiment of this application provides a communication device test method. As shown in FIG. 3, the communication device test method provided in this embodiment of this application includes the following step 201 to step 204.

Step 201: TE sends a first signal to a DUT.

The first signal is a signal corresponding to a first test case.

In this embodiment of this application, a proper test procedure is provided for an AI/ML model-based communication system. That is, for the first test case, the TE sends the signal corresponding to the first test case to the DUT. The DUT receives the first signal, processes the first signal, and sends a signal (that is, the following second signal) obtained by processing the first signal to the TE, so that the TE can process the second signal to obtain a test result corresponding to the first test case.

Optionally, in this embodiment of this application, the TE may be a test instrument such as a channel simulator, a base station simulator, a terminal simulator, an integrated measuring instrument, a signal analyzer, or a vector network analyzer, or a combination of one or more of the foregoing, or may be UE, a base station, a chip, or the like (having a corresponding test verification capability), or may be another device having a test verification capability. In addition, the DUT may be a terminal (for example, UE), a base station, a chip, or a combination of one or more of the foregoing. This may be determined based on an actual use requirement, and is not limited in this embodiment of this application.

Optionally, in this embodiment of this application, it is required that the TE in the test can verify an AI model-related capability. Tested entities may be connected via a conducted or over-the-air (OTA) manner, and a test system shall be performed in a corresponding test environment, such as but not limited to an anechoic chamber or a shielded room.

Optionally, in this embodiment of this application, the first signal includes a positioning reference signal (PRS), a channel state information-reference signal (CSI-RS), or the like. In addition, the first test case includes positioning, CSI compression, beam management, and the like. When the first test case includes positioning, the first signal is a PRS; or when the first test case includes CSI compression, the first signal is a CSI-RS. This may be determined based on an actual use requirement, and is not limited in this embodiment of this application.

Step 202: The DUT receives the first signal sent by the TE.

Step 203: The DUT processes the first signal, and sends a second signal to the TE.

In this embodiment of this application, the second signal includes at least one of the following: a signal obtained by processing the first signal by using a reference model with an AI functionality, a signal obtained by performing non-AI functionality processing on the first signal, or a signal obtained by processing the first signal by using an AI model. The second signal is used to obtain the test result corresponding to the first test case, that is, the second signal is used for processing by the TE to obtain the test result corresponding to the first test case.

Optionally, in this embodiment of this application, the DUT processes the first signal. Based on a processing method implemented by the DUT, the processed first signal may obtain measurement values corresponding to related test metrics (for example, an RSTD and an RSRP) of the first test case or metrics (for example, a delay and an interruption) corresponding to core requirements. These measurement values or metrics are reported to the TE by using the second signal.

Optionally, in this embodiment of this application, the DUT may process the first signal by using a reference model with an AI functionality; or the DUT may perform non-AI functionality processing on the first signal without using a reference model; or the DUT may process the first signal by using an AI model of the DUT.

Optionally, in this embodiment of this application, the performing non-AI functionality processing on the first signal may be processing the first signal by using a conventional communication architecture (for example, a communication architecture without an AI functionality).

Optionally, in this embodiment of this application, the foregoing reference model is an AI model specified in the protocol, and may also be referred to as a reference AI model. The processing the first signal by using a reference model with an AI functionality may be understood as processing the first signal by using the reference model specified in the protocol in the AI model. The processing the first signal by using an AI model may be understood as processing the first signal by using an AI model provided by a device manufacturer of the DUT.

Optionally, in this embodiment of this application, when the first test case includes positioning, test metrics of the positioning include metrics corresponding to measurement quantity precision such as an RSTD, an RSRP, an RSRPP, a UE Rx-Tx time difference, an angle of arrival (AoA), an angle of departure (AoD), a line of sight (LOS) indicator, a non-line of sight (NLOS) indicator, and a final position. Alternatively, test metrics of the positioning include metrics corresponding to core requirements such as a delay and an interruption. This may be determined based on an actual use requirement, and is not limited in this embodiment of this application.

Optionally, in this embodiment of this application, when the first test case includes CSI compression, test metrics of the CSI compression include metrics corresponding to measurement quantities such as a squared generalized cosine similarity (SGCS), a normalized mean squared error (NMSE), a throughput, and a block error rate (BLER). Alternatively, test metrics of the CSI compression include metrics corresponding to core requirements such as a delay and an interruption. This may be determined based on an actual use requirement, and is not limited in this embodiment of this application.

Step 204: The TE receives the second signal sent by the DUT, and processes the second signal to obtain a test result corresponding to the first test case.

Optionally, in this embodiment of this application, the test result includes at least one of the following: an absolute amount of a test result of executing an AI functionality, an absolute amount of a test result of not executing an AI functionality, or a relative amount between a test result of executing an AI functionality and a test result of not executing an AI functionality.

Optionally, in this embodiment of this application, the test result includes at least one test result, and each test result is a test result corresponding to one wireless scenario or one configuration supported by the DUT.

Optionally, in this embodiment of this application, the wireless scenario or the configuration is a wireless scenario or a configuration specified (predefined) within a capability range of the DUT. In addition, the wireless scenario or the configuration includes a wireless channel or a hardware configuration (for example, an antenna).

Optionally, in this embodiment of this application, the wireless scenario or the configuration includes an indoor hotspot coverage scenario (Indoor Office), an urban micro (UMi) cell, an urban macro (UMa) cell, an indoor factory with high Tx and high Rx (InF-HH), an indoor factory with sparse clutter and high base station height (InF-SH), an Indoor factory with sparse clutter and low base station height (InF-SL), an indoor factory with dense clutter and high base station height (InF-DH), an indoor factory with dense clutter and low base station height (InF-DL), and the like. Each wireless scenario or configuration corresponds to one group of model parameters, or all wireless scenarios or configurations correspond to a same model parameter.

Optionally, in this embodiment of this application, each test result in the at least one test result includes at least one of the following: an absolute amount of a test result of executing an AI functionality, an absolute amount of a test result of not executing an AI functionality, or a relative amount between a test result of executing an AI functionality and a test result of not executing an AI functionality.

Optionally, in this embodiment of this application, after the test result in the first test case is obtained, the test result may be compared with a pass or fail threshold to determine whether device performance of the DUT in the first test case passes the test. For example, the device performance of the DUT may be determined in the following manner:
when a test result that does not meet a first preset condition exists in the at least one test result, device performance of the DUT fails the test; or
when a ratio of a first quantity to a second quantity is less than a first threshold, device performance of the DUT fails the test, where the first quantity is a quantity of test results that the device performance of the DUT passes the test in the at least one test result, and the second quantity is a quantity of the at least one test result; or
when performance information corresponding to the at least one test result does not meet a second preset condition, device performance of the DUT fails the test, where the performance information is used to represent device performance corresponding to the at least one test result.

It can be understood that, in the first manner, a fulfillment requirement corresponding to a single wireless scenario or configuration is used as a judging criterion. When device performance in one wireless scenario or one configuration does not meet the requirement, the device performance of the DUT does not meet the requirement; or when device performance in all supported wireless scenarios or configurations meets the requirement, the device performance of the DUT meets the requirement.

In the second manner, a quantity of wireless scenarios or configurations passing the test is used as a judging criterion. The first threshold is set, and the first threshold is a ratio of a quantity of wireless scenarios or configurations passing the test to a total quantity of tested wireless scenarios or configurations. When a fulfillment rate of the at least one test result is less than the first threshold, the device performance of the DUT does not meet the requirement; or when a fulfillment rate of the at least one test result is greater than or equal to the first threshold, the device performance of the DUT meets the requirement.

In the third manner, total performance of the DUT in a plurality of wireless scenarios or configurations is used as a judging criterion. When the total performance of the DUT does not meet the requirement, the device performance of the DUT does not meet the requirement; or when the total performance of the DUT meets the requirement, the device performance of the DUT meets the requirement.

Optionally, in this embodiment of this application, that the device performance or the performance does not meet the requirement means that the device performance or the performance does not meet a performance metric requirement specified in the protocol. That the device performance or the performance meets the requirement means that the device performance or the performance meets the performance metric requirement specified in the protocol. For example, an RSRP value obtained through the test is greater than an RSRP requirement specified in TS 38.133.

Optionally, in this embodiment of this application, that a test result that does not meet a first preset condition exists in the at least one test result means that a test result that does not meet the performance metric requirement specified in the protocol exists in the at least one test result. That performance information corresponding to the at least one test result does not meet a second preset condition means that the performance information does not meet the performance metric requirement specified in the protocol.

For example, when a performance metric includes a throughput and the throughput is less than a second threshold specified in the protocol, the device performance of the DUT fails the test. When the performance metric includes a delay and the delay is greater than a third threshold specified in the protocol, the device performance of the DUT fails the test. It can be understood that different performance metrics correspond to different determining thresholds, and different performance metrics correspond to different determining conditions.

Optionally, in this embodiment of this application, the device performance is a metric or a result that can represent overall performance of the DUT and that is obtained in an entire test process. The performance information includes an average, a root mean square error, a normalized value, a value at 90% on a cumulative distribution function (CDF) curve, and the like. This may be determined based on an actual use requirement, and is not limited in this embodiment of this application.

Optionally, in this embodiment of this application, the determining process may be independently determined by the DUT or the TE, or may be manually determined by a tester, or may be determined by another related device or program (for example, an automated test program in some computer devices). This may be determined based on an actual use requirement, and is not limited in this embodiment of this application.

This embodiment of this application provides a communication device test method. TE sends a signal corresponding to a first test case to a DUT, and the DUT receives the first signal, processes the first signal by using a reference model with an AI functionality or an AI model or performs non-AI functionality processing on the first signal, and sends a signal (that is, a second signal) obtained by processing the first signal to the TE, so that the TE can process the second signal to obtain a test result corresponding to the first test case. In this solution, the reference model with the AI functionality is introduced as a reference for defining a unified performance requirement, so that the DUT can process, by using the reference model, the signal sent by the TE, and the TE obtains the corresponding test result based on the signal processed by the DUT. In this way, this application provides a comprehensive test procedure for an AI/ML model-based communication device, thereby effectively overcoming the difficulty in applying a conventional test technology to the AI/ML model-based communication device.

Optionally, in this embodiment of this application, the reference model meets any one of the following:
the reference model is used only for the DUT in a 1-sided AI/ML model framework;
the reference model is used for the TE and the DUT in a 2-sided AI/ML model framework, and a structure of a first reference model used for the TE matches that of a second reference model used for the DUT; or
the reference model is used only for the TE in a 2-sided AI/ML model framework.

In other words, only the DUT uses (or implements) the reference model in the 1-sided AI/ML model framework;
both the TE and the DUT use the reference model in the 2-sided AI/ML model framework, and the structure of the first reference model used for the TE matches that of the second reference model used for the DUT; or
only the TE uses the reference model in the 2-sided AI/ML model framework.

It should be noted that the 1-sided AI/ML model framework means that an AI model is deployed only on one of the device under test side and the test equipment side. The 2-sided AI/ML model framework means that AI models are separately deployed on the device under test side and the test equipment side, and the models on both sides match each other.

Optionally, in this embodiment of this application, that a structure of a first reference model used for the TE matches that of a second reference model used for the DUT may be: the structure of the first reference model used for the TE is the same as that of the second reference model used for the DUT; or the structure of the first reference model used for the TE may match that of the second reference model used for the DUT in any other possible form. This may be determined based on an actual use requirement, and is not limited in this embodiment of this application.

Optionally, in this embodiment of this application, when the reference model is used only for the DUT, the DUT may choose to use one or more reference models supported by a capability of the DUT, and the used reference model corresponds to a test case, a wireless scenario, or a configuration. Considering a storage capability or a processing capability of the DUT, when the storage capability or the processing capability of the DUT does not reach a specified level, a quantity of actually used reference models may be less than a maximum quantity of reference models supported by the capability of the DUT.

Optionally, in this embodiment of this application, when the reference model is used for the TE and the DUT, the DUT and the TE may choose to use a pair (that is, one or more reference model pairs) composed by one or more groups of reference models, and the used reference model pair corresponds to a test case, a wireless scenario, or a configuration. Considering a storage capability or a processing capability of the DUT, when the storage capability or the processing capability of the DUT does not reach a specified level, a quantity of actually used reference model pairs may be less than a maximum quantity of reference model pairs supported by the capability of the DUT.

Optionally, in this embodiment of this application, when the reference model is used only for the TE, the used reference model corresponds to a test case, a wireless scenario, or a configuration.

Optionally, in this embodiment of this application, the reference model is obtained based on any one of the following:
a predefined model structure and a model parameter; or
a predefined model structure.

It can be understood that the reference model may be specified in advance in the protocol, that is, a structure and a parameter of the reference model are specified, or only a structure of the reference model is specified.

Optionally, in this embodiment of this application, the reference model is obtained based on any one of the following:
a predefined complete model structure and all model parameters;
a predefined complete model structure and partial model parameters;
a predefined partial model structure and partial parameters;
a predefined complete model structure; or
a predefined partial model structure.

It can be understood that the reference model may be specified in advance in the protocol. For example, the complete model structure and all model parameters are specified, or the complete model structure and partial model parameters are specified, or the partial model structure and partial model parameters are specified, or the complete model structure is specified, or the partial model structure is specified.

Optionally, in this embodiment of this application, a model structure and a model parameter that are not predefined (unspecified) are determined by the implementation of the TE or the DUT.

Optionally, in this embodiment of this application, when the reference model is obtained based on the predefined model structure and the model parameter, the reference model includes at least one predefined model structure and at least one group of model parameters corresponding to each model structure; and each model structure and one group of model parameters in the at least one group of model parameters corresponding to each model structure constitute one reference model, or every two matched model structures and respective corresponding groups of model parameters constitute one reference model pair.

Optionally, in this embodiment of this application, one wireless scenario or one configuration corresponds to at least one group of model parameters. That is, one wireless scenario or one configuration corresponds to one or more groups of model parameters.

In one example, for the 1-sided model framework, the reference model meets that the reference model is used only for the DUT in the 1-sided AI/ML model framework. At least one model structure and one or more groups of model parameters corresponding to each model structure may be predefined for the DUT, and each model structure and one group of model parameters corresponding to each model structure constitute one reference model.

In one example, for the 2-sided model framework, the reference model meets that the reference model is used for the TE and the DUT. At least one model structure and one or more groups of model parameters corresponding to each model structure may be predefined for the DUT or the TE, and every two matched model structures and respective corresponding groups of model parameters constitute one reference model pair.

In one example, for the 2-sided model framework, the reference model meets that the reference model is used only for the TE. At least one model structure and one or more groups of model parameters corresponding to each model structure may be predefined for the TE, and each model structure and one group of model parameters corresponding to each model structure constitute one reference model.

Optionally, in this embodiment of this application, when the reference model is obtained based on the predefined model structure, the reference model includes at least one predefined model structure; and each model structure corresponds to one reference model, or each model structure corresponds to one reference model pair.

In one example, for the 1-sided model framework, the reference model meets that the reference model is used only for the DUT in the 1-sided AI/ML model framework. At least one model structure may be predefined for the DUT, and each model structure corresponds to one reference model.

In one example, for the 2-sided model framework, the reference model meets that the reference model is used for the TE and the DUT. At least one model structure may be predefined for the DUT or the TE, and each model structure corresponds to one reference model pair.

In one example, for the 2-sided model framework, the reference model meets that only the TE uses the reference model. At least one model structure may be predefined for the TE, and each model structure corresponds to one reference model.

Optionally, in this embodiment of this application, the reference model is obtained based on the predefined model structure, and the reference model meets that the reference model is used only for the DUT in the 1-sided AI/ML model framework. The communication device test method provided in this embodiment of this application further includes the following step 301a or step 301b.

Step 301a: The DUT determines the reference model based on the predefined model structure and a model training dataset.

Step 301b: The DUT determines the reference model based on the predefined model structure and a prestored model parameter.

Optionally, in this embodiment of this application, step 301a or step 301b may be performed before step 203.

Optionally, in this embodiment of this application, the DUT may train a complete reference model based on the predefined model structure and the predefined model training dataset; or the DUT may obtain a complete reference model based on the predefined model structure and the prestored model parameter.

In this embodiment of this application, when only the model structure is predefined, the DUT may obtain the complete reference model based on the predefined model training dataset or the prestored model parameter, to test an AI/ML model-based communication device by using the complete reference model, thereby ensuring accuracy of a test process.

Optionally, in this embodiment of this application, the reference model is obtained based on the predefined model structure, and the reference model meets that the reference model is used only for the TE in the 2-sided AI/ML model framework. The communication device test method provided in this embodiment of this application further includes the following step 302a or step 302b.

Step 302a: The TE determines the reference model based on the predefined model structure and a model training dataset.

Step 302b: The TE determines the reference model based on the predefined model structure and a prestored model parameter.

Optionally, in this embodiment of this application, step 302a or step 302b may be performed before step 204.

Optionally, in this embodiment of this application, the TE may train a complete reference model based on the predefined model structure and the predefined model training dataset; or the TE may obtain a complete reference model based on the predefined model structure and the prestored model parameter.

In this embodiment of this application, when only the model structure is predefined, the TE may obtain the complete reference model based on the predefined model training dataset or the prestored model parameter, to test an AI/ML model-based communication device by using the complete reference model, thereby ensuring accuracy of a test process.

Optionally, in this embodiment of this application, the reference model is obtained based on the predefined model structure, and the reference model meets that the reference model is used for the TE and the DUT in the 2-sided AI/ML model framework. The communication device test method provided in this embodiment of this application further includes the following step 401a, step 401b, or step 401c.

Step 401a: The DUT determines a reference model sent by the TE as the reference model.

Step 401b: The DUT determines the reference model based on the predefined model structure and a model parameter sent by the TE.

Step 401c: The DUT performs joint training with the TE based on the predefined model structure and a reference training dataset, to obtain the reference model.

Optionally, in this embodiment of this application, step 401a, step 401b, or step 401c may be performed before step 203.

Optionally, in this embodiment of this application, when the DUT and the TE support model transfer, the TE performs model training based on the predefined model structure and the model training dataset, and sends the complete reference model obtained through training or the model parameter obtained through training to the DUT. Alternatively, when the DUT and the TE support model transfer, the TE sends the prestored model parameter to the DUT, or the TE sends the complete reference model obtained based on the predefined model structure and the prestored model parameter to the DUT. Alternatively, the DUT performs joint training with the TE on respective sides based on the predefined model structure and the reference training dataset, to obtain the complete reference model.

Optionally, in this embodiment of this application, the reference training dataset is a training dataset corresponding to the reference model.

Optionally, in this embodiment of this application, the reference training dataset is a training dataset corresponding to a reference model specified in the protocol.

Optionally, in this embodiment of this application, the reference model is obtained based on the predefined model structure, and the reference model meets that the reference model is used for the TE and the DUT in the 2-sided AI/ML model framework. The communication device test method provided in this embodiment of this application further includes the following steps 402a, 402b, or 402c.

Step 402a: The TE determines a reference model sent by the DUT as the reference model.

Step 402b: The TE determines the reference model based on the predefined model structure and a model parameter sent by the DUT.

Step 402c: The TE performs joint training with the DUT based on the predefined model structure and a reference training dataset, to obtain the reference model.

Optionally, in this embodiment of this application, step 402a, step 402b, or step 402c may be performed before step 204.

Optionally, in this embodiment of this application, when the DUT and the TE support model transfer, the DUT performs model training based on the predefined model structure and the model training dataset, and sends the complete reference model obtained through training or the model parameter obtained by through to the TE. Alternatively, when the DUT and the TE support model transfer, the DUT sends the prestored model parameter to the TE, or the DUT sends the complete reference model obtained based on the predefined model structure and the prestored model parameter to the TE. Alternatively, the TE performs joint training with the DUT on respective sides based on the predefined model structure and the reference training dataset corresponding to the reference model, to obtain the complete reference model.

Optionally, in this embodiment of this application, the reference training dataset is a training dataset corresponding to the reference model.

Optionally, in this embodiment of this application, the reference training dataset is a training dataset corresponding to a reference model specified in the protocol.

Optionally, in this embodiment of this application, the reference model is obtained based on the predefined model structure. The communication device test method provided in this embodiment of this application further includes the following step 501a or step 501b.

Step 501a: The DUT determines the reference model based on the predefined model structure and a reference training dataset corresponding to the reference model.

The reference model supports all wireless scenarios or configurations.

Step 501b: The DUT determines at least one reference model based on the predefined model structure and at least one group of reference training datasets corresponding to the reference model.

Each reference model supports one wireless scenario or one configuration.

Optionally, in this embodiment of this application, one model structure corresponds to at least one group of reference training datasets, and one group of reference training datasets corresponds to at least one wireless scenario or configuration.

Optionally, in this embodiment of this application, the reference model is obtained based on the predefined model structure. The communication device test method provided in this embodiment of this application further includes the following step 502a or step 502b.

Step 502a: The TE determines the reference model based on the predefined model structure and a reference training dataset corresponding to the reference model.

The reference model supports all wireless scenarios or configurations.

Step 502b: The TE determines at least one reference model based on the predefined model structure and at least one group of reference training datasets corresponding to the reference model.

Each reference model supports one wireless scenario or one configuration.

Optionally, in this embodiment of this application, one model structure corresponds to at least one group of reference training datasets, and one group of reference training datasets corresponds to at least one wireless scenario or configuration.

Optionally, in this embodiment of this application, the DUT or the TE may use the reference training dataset as a source of the model parameter during model training. One model structure corresponds to at least one group of reference training datasets. In one or more test cases, when it is predefined that only one reference model corresponds to all wireless scenarios or configurations supported by the DUT, for all wireless scenarios or configurations, the DUT or the TE uses a same reference training dataset for training. When it is predefined that a plurality of reference models correspond to different wireless scenarios or configurations, for each wireless scenario or configuration, the DUT or the TE uses at least one group of reference training datasets corresponding to the wireless scenario or the configuration for training.

Optionally, in this embodiment of this application, the communication device test method provided in this embodiment of this application further includes the following step 601.

Step 601: The TE loads at least one group of test data.

The at least one group of test data is determined based on a wireless scenario or a configuration supported by the TE and target information, where the target information includes any one of the following: a stationary statistical channel model, a non-stationary statistical channel model, a field measurement result, or deterministic channel modeling; or the at least one group of test data is a predefined test dataset corresponding to a wireless scenario or a configuration.

Optionally, in this embodiment of this application, the TE may load at least one group of test data in a test process in real time. It should be noted that the test data is data input for AI/ML model inference in the test process.

Optionally, in this embodiment of this application, the TE may generate at least one group of test data based on a wireless scenario or a configuration supported by the TE through an implementation method of the TE, or the TE may directly use a detailed dataset corresponding to a wireless scenario or a configuration as at least one group of test data.

Optionally, in this embodiment of this application, each group of test data corresponds to one wireless scenario or one configuration supported by the TE.

The following describes implementation of the reference model in the test process in this embodiment of this application.

For the 1-sided model framework:

Step S21: The TE loads a test dataset (that is, at least one group of test data) to simulate a wireless scenario or a configuration for testing, and the DUT deploys a corresponding reference model based on the foregoing principle.

Step S22: The DUT processes, by using the reference model, a signal sent by the TE, where a signal obtained after necessary processing is performed by the DUT on the processed signal is used as an output signal of the DUT. Optionally, the DUT processes, without using the reference model, a signal sent by the TE, but processes the signal by using a conventional architecture with a non-AI functionality, to obtain a signal as an additional output signal of the DUT.

Step S23: The output signal of the DUT is used as an input signal of the TE, and after processing the input signal, the TE obtains a test result of executing an AI functionality by the DUT by using the reference model. If an output of the DUT includes an additional output signal, after processing the additional output signal, the TE obtains a test result of not executing an AI functionality by the DUT.

Step S24: Based on the foregoing step, the obtained test result may include: an absolute quantity of a test result of executing an AI functionality by the DUT, an absolute quantity of a test result of not executing an AI functionality by the DUT, or a relative quantity between a test result of executing an AI functionality by the DUT and a test result of not executing an AI functionality by the DUT.

Step S25: Compare the obtained test result with a corresponding pass or fail threshold to determine whether the test is passed.

For the 2-sided model framework:

Step S31: The TE loads a test dataset (that is, at least one group of test data) to simulate a wireless scenario or a configuration for testing. When the reference model meets that both the TE and the DUT use the reference model, the TE or the DUT deploys a corresponding reference model pair based on the foregoing principle. When the reference model meets that only the TE uses the reference model, the TE deploys a corresponding reference model based on the foregoing principle.

Step S32a: When the reference model meets that both the TE and the DUT use the reference model, the DUT processes, by using the reference model, a signal sent by the TE, where a signal obtained after necessary processing is performed by the DUT on the processed signal is used as an output signal of the DUT. Optionally, the DUT processes, without using the reference model, a signal sent by the TE, but processes the signal by using a conventional architecture with a non-AI functionality, to obtain a signal as an additional output signal of the DUT.

Step S32b: When the reference model meets that only the TE uses the reference model, the DUT processes, by using an AI model, a signal sent by the TE, where the processed signal is used as an output signal of the DUT. Optionally, the DUT processes the signal by using a conventional architecture with a non-AI functionality, to obtain a signal as an additional output signal of the DUT.

Step S33: The output signal of the DUT is used as an input signal of the TE, and after processing the input signal by using the reference model, the TE obtains a test result of executing an AI functionality by the DUT. If an output of the DUT includes an additional output signal, a test result after the TE performs non-AI functionality processing on the additional output signal is obtained.

Step S34: Based on the foregoing step, the obtained test result may include: an absolute quantity of a test result of executing an AI functionality by the DUT or the TE, an absolute quantity of a test result of not executing an AI functionality by the DUT or the TE, or a relative quantity between a test result of executing an AI functionality by the DUT or the TE and a test result of not executing an AI functionality by the DUT or the TE.

Step S35: Compare the obtained test result with a corresponding pass or fail threshold to determine whether the test is passed.

Optionally, in this embodiment of this application, when each wireless scenario or configuration is tested, a test result corresponding to the wireless scenario or the configuration is recorded, and device performance of the DUT in each wireless scenario or configuration is determined, to evaluate generalization performance of the device.

Optionally, in this embodiment of this application, the test result includes a plurality of test results, and the plurality of test results include a result obtained after the TE dynamically switches a wireless scenario or a configuration supported by the TE, or a result obtained after the TE dynamically switches test data corresponding to a wireless scenario or a configuration supported by the TE.

It can be understood that the TE may dynamically switch a wireless scenario or a configuration, or the TE may dynamically switch test data corresponding to a wireless scenario or a configuration, record a test result corresponding to the wireless scenario or the configuration, and determine device performance of the DUT in the wireless scenario or the configuration, to evaluate generalization performance of the device.

Optionally, in this embodiment of this application, the plurality of test results include a result obtained after the TE dynamically switches a wireless scenario or a configuration or dynamically switches test data corresponding to a wireless scenario or a configuration within a preset test time; or

the plurality of test results include a result obtained after the TE dynamically switches a wireless scenario or a configuration or dynamically switches test data corresponding to a wireless scenario or a configuration in a plurality of preset wireless scenarios or configurations.

Optionally, in this embodiment of this application, the plurality of test results include results obtained by performing a test in all to-be-tested wireless scenarios or configurations supported by the TE; or
the plurality of test results include a result obtained by performing a test after the TE randomly switches a wireless scenario or a configuration; or
the plurality of test results include a result obtained by performing a test after the TE switches, based on a preset rule, a wireless scenario or a configuration supported by the TE.

It can be understood that a manner of selecting a to-be-tested wireless scenario or configuration includes any one of the following: exhaustively testing all wireless scenarios or configurations specified within a device capability range; randomly selecting a wireless scenario or a configuration for testing from all wireless scenarios or configurations specified within a device capability range; or selecting a wireless scenario or a configuration based on a preset probability or rule for testing from all wireless scenarios or configurations specified within a device capability range.

In one example, a total time for a single test is specified, and the time for the single test should be within a specified total time range. In a test process, a first wireless scenario or configuration is randomly selected or is selected based on a preset rule for testing from all wireless scenarios or configurations specified within a device capability range. After the wireless scenario or the configuration is tested, switching to another wireless scenario or configuration specified within the device capability range is randomly performed or is performed based on a preset rule for testing, and so on, until the time for the single test ends.

In another example, a quantity of wireless scenarios or configurations for a single test is specified, and the single test should be able to cover all supported wireless scenarios or configurations. In a test process, a first wireless scenario or configuration is randomly selected or is selected based on a preset rule for testing from all wireless scenarios or configurations. After the wireless scenario or the configuration is tested, switching to another wireless scenario or configuration in specified wireless scenarios or configurations is randomly performed or is performed based on a preset rule for testing, and so on, until all specified wireless scenarios or configurations are tested.

The following illustratively describes a predefining manner of the reference model in this embodiment of this application.

Criterion 1: A model structure and a model parameter of the reference model are predefined.

Case 1: A test case is positioning, a DUT is UE, and a reference model meets that only the UE uses the reference model in a 1-sided AI/ML model framework. The UE supports a CNN and a transformer as a model structure backbone. A predefining rule is as follows:
(a) The reference model of the UE uses the CNN as the model structure backbone.

The following scenarios are specified: Indoor Office, UMi, UMa, InF-HH, InF-SH, InF-SL, InF-DH, and InF-DL.

When a test scenario is Indoor Office, a corresponding model parameter set is A1.

When a test scenario is UMi, a corresponding model parameter set is A2.
(b) The reference model of the UE uses the transformer as the model structure backbone.

The following scenarios are specified: Indoor Office, UMi, UMa, InF-HH, InF-SH, InF-SL, InF-DH, and InF-DL.

When a test scenario is Indoor Office, a corresponding model parameter set is B1.

When a test scenario is UMi, a corresponding model parameter set is B2.
(c) The reference model of the UE uses the CNN as the model structure backbone.

The following scenarios are specified: Indoor Office, UMi, UMa, InF-HH, InF-SH, InF-SL, InF-DH, and InF-DL.

It is specified that a model parameter set C is applicable to all the foregoing scenarios.
(d) The reference model of the UE uses the transformer as the model structure backbone.

The following scenarios are specified: Indoor Office, UMi, UMa, InF-HH, InF-SH, InF-SL, InF-DH, and InF-DL.

It is specified that a model parameter set D is applicable to all the foregoing scenarios.

The UE actually uses the reference model in a test process in the following manners:
(1) When a capability of the UE supports use of one reference model:

Based the foregoing (a) and (b), the UE can select only one reference model. When a model structure backbone of the reference model is a CNN, a model parameter corresponding to the UE is one of A1, A2,..., for example, CNN-A2, which is applicable only to a positioning scenario UMi. When a model structure backbone of the reference model is a transformer, a parameter corresponding to the UE is one of B1, B2,..., for example, transformer-B1, which is applicable only to a positioning scenario Indoor Office.

Based on the foregoing (c) and (d), the UE can select only one reference model. When a model structure backbone of the reference model is a CNN, a model parameter corresponding to the UE is C, that is, CNN-C, which is applicable to all positioning scenarios. When a model structure backbone of the reference model is a transformer, a model parameter corresponding to the UE is D, that is, transformer-D, which is applicable to all positioning scenarios.
(2) When a capability of the UE supports use of a plurality of reference models:

Based on the foregoing (a) and (b), the UE may select, based on a processing capability or a storage capability of the UE, reference models whose quantity is less than or equal to a maximum quantity of reference models supported by the capability of the UE. That is, a quantity M of reference models that can be used by the UE is less than or equal to a maximum quantity N of reference models supported by the UE. For example, the UE stores a maximum of N=10 reference models, and may select M=5 reference models in this case, that is, CNN-A1, CNN-A2, CNN-A3, transformer-B1, and transformer-B2, which are applicable to three positioning scenarios Indoor Office, UMi, and Uma.

Case 2: A test case is CSI compression, a DUT is UE, and a reference model meets that both TE and the DUT use the reference model in a 2-sided AI/ML model framework. The UE supports a CNN and a transformer as a model structure backbone. A predefining rule is as follows:
(a) The reference model of the UE and the TE uses the CNN as the model structure backbone.

The following scenarios are specified: Indoor Office, UMi, and Uma.

When a test scenario is Indoor Office, a corresponding model parameter set is AUE1-ATE1, where A_{UE1} is implemented in the reference model of the UE and A_{TE1} is implemented in the reference model of the TE.

When a test scenario is UMi, a corresponding model parameter set is A_{UE2}-A_{TE2}, where A_{UE2} is implemented in the reference model of the UE, and A_{TE2} is implemented in the reference model of the TE.
(b) The reference model of the UE and the TE uses the transformer as the model structure backbone.

The following scenarios are specified: Indoor Office, UMi, and UMa.

When a test scenario is Indoor Office, a corresponding model parameter set is BUE1-BTE1, where B_{UE1} is implemented in the reference model of the UE, and B_{TE1} is implemented in the reference model of the TE.

When a test scenario is UMi, a corresponding model parameter set is B_{UE2}-B_{TE2}, where B_{UE2} is implemented in the reference model of the UE, and B_{TE2} is implemented in the reference model of the TE.
(c) The reference model of the UE and the TE uses the CNN as the model structure backbone.

The following scenarios are specified: Indoor Office, UMi, and UMa.

It is specified that a model parameter set C_{UE}-C_{TE} is applicable to all the foregoing scenarios, where C_{UE} is implemented in the reference model of the UE and C_{TE} is implemented in the reference model of the TE.
(d) The reference model of the UE and the TE uses the transformer as the model structure backbone.

The following scenarios are specified: Indoor Office, UMi, and UMa.

It is specified that a model parameter set D_{UE}-D_{TE} is applicable to all the foregoing scenarios, where D_{UE} is implemented in the reference model of the UE and D_{TE} is implemented in the reference model of the TE.

The UE or the TE actually uses the reference model in a test process in the following manners:
(1) When a capability of the UE supports use of one reference model:

Based the foregoing (a) and (b), the UE can select only one reference model. When a model structure backbone of the reference model is a CNN, model parameters corresponding to the UE and the TE are one of A_{UE1}-A_{TE1}, A_{UE2}-A_{TE2},..., for example, CNN-A_{UE2}-A_{TE2}, which is applicable only to a CSI compression scenario UMi. When a model structure backbone of the reference model is a transformer, model parameters corresponding to the UE and the TE are one of B_{UE1}-B_{TE1}, B_{UE2}-B_{TE2},..., for example, transformer-B_{UE1}-B_{TE1}, which is applicable only to a CSI compression scenario Indoor Office.

Based on the foregoing (c) and (d), the UE can select only one reference model. When a model structure backbone of the reference model is a CNN, model parameters corresponding to the UE and the TE are C_{UE}-C_{TE}, that is, CNN-C_{UE}-C_{TE}, which is applicable to all CSI compression scenarios. When a model structure backbone of the reference model is a transformer, model parameters corresponding to the UE and the TE are D_{UE}-D_{TE}, that is, transformer-D_{UE}-D_{TE}, which is applicable to all CSI compression scenarios.
(2) When a capability of the UE supports use of a plurality of reference models:
Based on the foregoing (a) and (b), the UE may select, based on a processing capability or a storage capability of the UE, reference models whose quantity is less than or equal to a maximum quantity of reference models supported by the capability of the UE. That is, a quantity M of reference models that can be used by the UE is less than or equal to a maximum quantity N of reference models supported by the UE. For example, the UE stores a maximum of N=10 reference models, and may select M=5 reference models in this case, that is, CNN-AUE1-ATE1, CNN-A_{UE2}-A_{TE2}, CNN-A_{UE3}-A_{TE3}, transformer-B_{UE1}-B_{TE1}, and transformer-B_{UE2}-B_{TE2}, which are applicable to three CSI compression scenarios Indoor Office, UMi, and Uma.

Case 3: A test case is CSI compression, a DUT is UE, and a reference model meets that only TE uses the reference model in a 2-sided AI/ML model framework. A predefining rule in this case is the same as the predefining rule in case 1 in Criterion 1, but is implemented on the TE side, and a processing capability and a storage capability of the TE do not need to be considered.

Criterion 2: Model structure of the reference model is predefined.

Case 1: A test case is positioning, a DUT is UE, and a reference model meets that only the UE uses the reference model in a 1-sided AI/ML model framework. The UE supports a CNN and a transformer as a model structure backbone. A predefining rule is as follows:
(a) The reference model of the UE uses the CNN as the model structure backbone.

It is specified that the CNN is applicable to the following scenarios: Indoor Office, UMi, UMa, InF-HH, InF-SH, InF-SL, InF-DH, and InF-DL.
(b) The reference model on the UE side uses the transformer as the model structure backbone.

It is specified that the transformer is applicable to the following scenarios: Indoor Office, UMi, UMa, InF-HH, InF-SH, InF-SL, InF-DH, and InF-DL.

The UE actually uses the reference model in a test process in the following manners:
(1) When a capability of the UE supports use of one reference model:

When a model structure backbone of the reference model is a CNN, a model parameter provided by a device vendor for the foregoing scenario is one of A1, A2,..., for example, CNN-A2, which is applicable only to a positioning scenario UMi. When a model structure backbone of the reference model is a transformer, a model parameter provided by a device vendor for the foregoing scenario is one of B1, B2,..., for example, transformer-B1, which is applicable only to a positioning scenario Indoor Office.

Alternatively, when a model structure backbone of the reference model is a CNN, a model parameter provided by a device vendor for all the foregoing scenarios is C, that is, CNN-C, which is applicable to all positioning scenarios. When a model structure backbone of the reference model is a transformer, a model parameter provided by a device vendor for all the foregoing scenarios is D, that is, transformer-D, which is applicable to all positioning scenarios.
(2) When a capability of the UE supports use of a plurality of reference models:

When a model structure backbone of the reference model is a CNN, a model parameter provided by a device vendor for the foregoing scenario is one of A1, A2,.... When a model structure backbone of the reference model is a transformer, a model parameter provided by a device vendor for the foregoing scenario is one of B1, B2,.... The UE may select, based on a processing capability or a storage capability of the UE, reference models whose quantity is less than or equal to a maximum quantity of reference models supported by the capability of the UE. That is, a quantity M of reference models that can be used by the UE is less than or equal to a maximum quantity N of reference models supported by the UE. For example, the UE stores a maximum of N=10 reference models, and may select M=5 reference models in this case, that is, CNN-A1, CNN-A2, CNN-A3, transformer-B1, and transformer-B2, which are applicable to three positioning scenarios Indoor Office, UMi, and Uma.

Case 2: A test case is CSI compression, a DUT is UE, and a reference model meets that both TE and the DUT use the reference model in a 2-sided AI/ML model framework. The UE supports a CNN and a transformer as a model structure backbone. A predefining rule is as follows:
(a) The reference model of the UE and the TE uses the CNN as the model structure backbone.

The following scenarios are specified: Indoor Office, UMi, and Uma.
(b) The reference model of the UE and the TE uses the transformer as the model structure backbone.

The following scenarios are specified: Indoor Office, UMi, and Uma.

The UE or the TE actually uses the reference model in a test process in the following manners:
(1) When a capability of the UE supports use of one reference model:

When a model structure backbone of the reference model is a CNN, model parameters provided by a device vendor for the foregoing scenario is one of A_{UE1}-A_{TE1}, AUE2-ATE2,..., for example, CNN-A_{UE2}-A_{TE2}, which is applicable only to a CSI compression UMi. When a model structure backbone of the reference model is a transformer, model parameters provided by a device vendor for the foregoing scenario are one of B_{UE1}-B_{TE1}, B_{UE2}-B_{TE2},..., for example, transformer-B_{UE1}-B_{TE1}, which is applicable only to a CSI compression scenario Indoor Office.

Alternatively, when a model structure backbone of the reference model is a CNN, model parameters provided by a device vendor for all the foregoing scenarios is C_{UE}-C_{TE}, that is, CNN-C_{UE}-C_{TE}, which is applicable to all CSI compression scenarios. When a structure backbone of the reference model is a transformer, model parameters provided by a device vendor for all the foregoing scenarios is D_{UE}-D_{TE}, that is, transformer-D_{UE}-D_{TE}, which is applicable to all CSI compression scenarios.
(2) When a capability of the UE supports use of a plurality of reference models:

When a model structure backbone of the reference model is a CNN, model parameters provided by a device vendor for the foregoing scenario is one of A_{UE1}-A_{TE1}, AUE2-ATE2,.... When a model structure backbone of the reference model is a transformer, model parameters provided by a device vendor for the foregoing scenario is one of B_{UE1}-B_{TE1}, BUE2-BTE2,.... The UE may select, based on a processing capability or a storage capability of the UE, reference models whose quantity is less than or equal to a maximum quantity of reference models supported by the capability of the UE. That is, a quantity M of reference models that can be used by the UE is less than or equal to a maximum quantity N of reference models supported by the UE. For example, the UE stores a maximum of N=10 reference models, and may select M=5 reference models in this case, that is, CNN-A_{UE1}-A_{TE1}, CNN-A_{UE2}-A_{TE2}, CNN-A_{UE3}-A_{TE3}, transformer-B_{UE1}-B_{TE1}, and transformer-B_{UE2}-B_{TE2}, which are applicable to three CSI compression scenarios Indoor Office, UMi, and Uma.

Case 3: A test case is CSI compression, a DUT is UE, and a reference model meets that only TE uses the reference model in a 2-sided AI/ML model framework. A predefining rule in this case is the same as the predefining rule in case 1 in Criterion 2, but is implemented on the TE side, and a processing capability and a storage capability of the TE do not need to be considered.

The following illustratively describes an implementation of the reference model in this embodiment of this application.

Case 1: For a 1-sided model framework, a test case is a positioning test.

Step S41: The TE loads a test dataset to simulate a wireless scenario or a configuration for testing, and the UE deploys a corresponding reference model based on the foregoing principle.

Step S42: The UE processes, by using the reference model, a PRS sent by the TE. Based on a processing method implemented by the UE, the processed PRS may obtain measurement values of related metrics of the PRS and metrics such as a delay and an interruption. These metrics are reported to the TE by using an output signal sent by the UE. Optionally, the UE processes, without using the reference model, a PRS sent by the TE, but processes the PRS by using a conventional architecture with a non-AI functionality, to obtain measurement values of related metrics of the PRS and metrics such as a delay and an interruption. These metrics are used as an additional output signal of the UE.

Step S43: The measurement metric reported by the UE is input to the TE, and after processing the input signal, the TE obtains a test result of executing an AI functionality by the UE by using the reference model. If an output of the UE includes an additional output signal, after processing the additional output signal, the TE obtains a test result of not executing an AI functionality by the UE. A processing process of the TE includes: when a measurement quantity requires the UE to send another reference signal such as a sounding reference signal (SRS), the TE measures the SRS, and calculates a final metric based on a result of PRS measurement and a result of SRS measurement.

Step S44: Based on the foregoing step, the obtained test result may include: an absolute quantity of a test result of executing an AI functionality by the UE, an absolute quantity of a test result of not executing an AI functionality by the UE, or a relative quantity between a test result of executing an AI functionality by the UE and a test result of not executing an AI functionality by the UE.

Step S45: Compare the obtained test result with a corresponding pass or fail threshold to determine whether the test is passed.

Metrics of the positioning test include one or more of the following: a metric corresponding to measurement quantity precision such as an RSTD, an RSRP, an RSRPP, a UE Rx-Tx time difference, an AoA, an AoD, an LOS/NLOS indicator, or a final position; and a metric corresponding to a core requirement such as a delay or an interruption.

Metrics corresponding to a measurement quantity precision value and a core requirement of corresponding positioning are obtained based on the foregoing procedure, and then are compared with metric requirements that are corresponding to measurement quantity precision and a core requirement and that are specified in the protocol. A comparison process includes: (1) Being compared with metric requirements corresponding to measurement quantity precision and a core requirement of conventional positioning with a non-AI/ML feature. If this requirement is met, it indicates that performance of the positioning corresponding to the corresponding metrics under an AI/ML feature is better than performance of the conventional positioning. (2) Being compared with metric requirements corresponding to measurement quantity precision and a core requirement of positioning with an AI/ML feature. If this requirement is met, it indicates that the UE can meet required performance under the AI/ML feature. (3) Being compared with a relative value requirement between measurement precision and a core requirement of positioning with an AI/ML feature and those of positioning with a non-AI/ML feature. If this requirement is met, the positioning under the AI/ML feature has better performance improvement compared with conventional positioning. Theoretically, the metric requirements corresponding to the measurement quantity precision and the core requirement of the positioning under the AI/ML feature are higher than the metric requirements corresponding to the measurement quantity precision and the core requirement of the conventional positioning under the non-AI/ML feature.

Case 2: For a 2-sided model framework, a test case is a CSI compression test.

S51. The TE loads a test dataset to simulate a wireless scenario or a configuration for testing. When the reference model meets that both the TE and the DUT use the reference model, the TE or the UE deploys a corresponding reference model pair based on the foregoing principle. When the reference model meets that only the TE uses the reference model, the TE deploys a corresponding reference model based on the foregoing principle.

S52a. When the reference model meets that both the TE and the DUT use the reference model, the UE processes, by using the reference model, a CSI-RS sent by the TE. Based on a processing method implemented by the UE, the processed CSI-RS may obtain metrics such as an estimated channel feature, a delay, and an interruption. These metrics are reported to the TE by using an output signal sent by the UE. Optionally, the UE processes, without using the reference model, a CSI-RS sent by the TE, but processes the CSI-RS by using a conventional architecture with a non-AI functionality, to obtain metrics such as an estimated PMI value, a delay, and an interruption. These metrics are used as an additional output signal of the UE.

The UE processes, by using the reference model, a PRS sent by the TE. Based on a processing method implemented by the UE, the processed PRS may obtain measurement values of related metrics of the PRS and metrics such as a delay and an interruption. These metrics are reported to the TE by using an output signal sent by the UE. Optionally, the UE processes, without using the reference model, a PRS sent by the TE, but processes the PRS by using a conventional architecture with a non-AI functionality, to obtain measurement values of related metrics of the PRS and metrics such as a delay and an interruption. These metrics are used as an additional output signal of the UE.

S52b. When the reference model meets that only the TE uses the reference model, the UE processes, by using an AI model, a CSI-RS sent by the TE. Based on a processing method implemented by the UE, the processed CSI-RS may obtain metrics such as an estimated channel feature, a delay, and an interruption. These metrics are reported to the TE by using an output signal sent by the UE. Optionally, the UE processes a CSI-RS by using a conventional architecture with a non-AI functionality, to obtain metrics such as an estimated PMI value, a delay, and an interruption. These metrics are used as an additional output signal of the UE.

S53. The measurement metric reported by the UE is input to the TE, and after processing the input signal by using the reference model, the TE obtains a test result of executing an AI functionality by the UE. If an output of the UE includes an additional output signal, a test result of performing non-AI functionality processing on the additional output signal by the TE is obtained. A processing process of the TE includes one or more of the following: calculating an ideal channel feature based on a loaded wireless scenario or configuration, and performing processing and calculation on a channel feature reported by the UE and the ideal channel feature, to obtain an intermediate quantity in a CSI compression process as a test result; or obtaining a throughput and a BLER of the UE based on a channel feature reported by the UE as a test result.

S54. Based on the foregoing step, the obtained test result may include: an absolute quantity of a test result of executing an AI functionality by the DUT or the TE, an absolute quantity of a test result of not executing an AI functionality by the DUT or the TE, or a relative quantity between a test result of executing an AI functionality by the DUT or the TE and a test result of not executing an AI functionality by the DUT or the TE.

S55. Compare the obtained test result with a corresponding pass or fail threshold to determine whether the test is passed.

Metrics of the CSI compression test include one or more of the following: a cosine similarity, an NMSE, a throughput, a BLER, and a metric corresponding to a core requirement such as a delay or an interruption.

Metrics corresponding to a measurement quantity and a core requirement of corresponding CSI compression are obtained based on the foregoing procedure, and then are compared with metrics that are corresponding to a measurement quantity and a core requirement and that are specified in the protocol. A comparison process includes: (1) Being compared with metric requirements corresponding to a measurement quantity and a core requirement of conventional CSI compression with a non-AI/ML feature. If this requirement is met, it indicates that performance of the CSI compression corresponding to the corresponding metrics under an AI/ML feature is better than performance of the conventional CSI compression. (2) Being compared with metric requirements corresponding to a measurement quantity and a core requirement of CSI compression with an AI/ML feature. If this requirement is met, it indicates that the UE can meet required performance under the AI/ML feature. (3) Being compared with a relative value requirement between a measurement quantity and a core requirement of CSI compression with an AI/ML feature and those of CSI compression with a non-AI/ML feature. If this requirement is met, the CSI compression under the AI/ML feature has better performance improvement compared with conventional CSI compression. Theoretically, the metric requirements corresponding to the measurement quantity and the core requirement of the CSI compression with the AI/ML feature are higher than the metric requirements corresponding to the measurement quantity and the core requirement of the conventional CSI compression with the non-AI/ML feature.

The following illustratively describes a process of generating and testing a dataset with a generalization capability in this embodiment of this application.

Case 1: Test data is generated based on a stationary or non-stationary statistical channel model.

For M to-be-tested wireless scenarios or configurations (for example, InF, UMi, and UMa), the following test schemes are available:

Scheme 1: Test all wireless scenarios or configurations specified within a device capability range. One group of test data corresponds to one wireless scenario or one configuration.
(a) Generate, based on M to-be-tested wireless scenarios or configurations, a test dataset A corresponding to the stationary or non-stationary channel model, that is, A=[A₁, A₂,..., Aₘ, ..., A_{M}], where Aₘ is a test dataset corresponding to an m^{th} wireless scenario or configuration, and m∈[1,.., M]. The test dataset A may be a channel modeling parameter set or a channel model dataset corresponding to a wireless scenario or a configuration, a generated dataset suitable for an input of the DUT, or the like.
(b) Perform a test in the first wireless scenario or configuration, where used test data is generated based on a stationary channel model in the wireless scenario or the configuration.
(c) Exhaustively test all wireless scenarios or configurations in the M wireless scenarios or configurations.
(d) Record a test results corresponding to each wireless scenario or configuration, and determine whether performance in each wireless scenario or configuration meets a performance requirement specified in the protocol.

Scheme 2: Test a wireless scenario or a configuration selected randomly or selected based on a specific probability or rule in all wireless scenarios or configurations specified within a device capability range. One group of test data corresponds to one wireless scenario or one configuration.
(a) Generate, based on M to-be-tested wireless scenarios or configurations, a test dataset A corresponding to a stationary or non-stationary channel model, that is, A=[A₁, A₂,..., Aₘ, ..., A_{M}], where Aₘ is a test dataset corresponding to an m^{th} wireless scenario or configuration, and m∈[1,.., M]. The test dataset A may be a channel modeling parameter set or a channel model dataset corresponding to a wireless scenario or a configuration, a generated dataset suitable for an input of the DUT, or the like.
(b) In a test process, the TE switches a test dataset once at random at intervals of time t or based on a specific probability or rule, for example, switches from Aᵢ to Aⱼ, where i, j∈[1,.., M]. A sample quantity of test results is controlled by specifying a total time T of one test or a quantity N of wireless scenarios or configurations of one test.
(c) A compliance requirement for a single wireless scenario or configuration serves as an evaluation criterion. If one wireless scenario or one configuration does not meet the requirement, a device performance generalization capability does not meet the requirement in this test; or if a ratio of a quantity of wireless scenarios or configurations passing the test to a total quantity of tested wireless scenarios or configurations is greater than or equal to a preset threshold 90%, a device performance generalization capability meets the requirement in this test; or a value corresponding to 90% on a CDF curve corresponding to a test metric in this test is calculated, and if the value is greater than or equal to a preset threshold, a device performance generalization capability meets the requirement in this test.

Case 2: Test data is generated based on a field measurement result or deterministic channel modeling.

When generated channel data is a stationary channel, a test procedure corresponding to generating test data based on a stationary statistical channel model is followed. When generated channel data is a non-stationary channel, a test procedure corresponding to generating test data based on a non-stationary statistical channel model is followed.

Case 3: Test data is a detailed dataset corresponding to a wireless scenario or a configuration specified in the protocol.

The TE loads a file composed of detailed test data, and directly performs a test based on a required test objective and a test time or a specified wireless scenario or configuration.

The communication device test method provided in the embodiments of this application may be executed by a communication device test apparatus. In the embodiments of this application, an example in which the communication device test apparatus executes the communication device test method is used to describe the communication device test apparatus provided in the embodiments of this application.

An embodiment of this application provides a communication device test apparatus. As shown in FIG. 4, the communication device test apparatus 700 includes a receiving module 701, a processing module 702, and a sending module 703. The receiving module 701 is configured to receive a first signal sent by TE, where the first signal is a signal corresponding to a first test case. The processing module 702 is configured to process the first signal. The sending module 703 is configured to send a second signal to the TE, where the second signal includes at least one of the following: a signal obtained by processing the first signal by using a reference model with an AI functionality, a signal obtained by performing non-AI functionality processing on the first signal, or a signal obtained by processing the first signal by using an AI model; and the second signal is used to obtain a test result corresponding to the first test case.

In the communication device test apparatus provided in this embodiment of this application, a reference model with an AI functionality is introduced as a reference for defining a unified performance requirement. The test apparatus may process, by using the reference model, a signal sent by TE, so that the TE obtains a corresponding test result based on the signal processed by the test apparatus. In this way, this application provides a comprehensive test procedure for an AI/ML model-based communication device, thereby effectively overcoming the difficulty in applying a conventional test technology to the AI/ML model-based communication device.

Optionally, in this embodiment of this application, the reference model meets any one of the following:
the reference model is used only for the DUT in a 1-sided AI/ML model framework;
the reference model is used for the TE and the DUT in a 2-sided AI/ML model framework, and a structure of a first reference model used for the TE matches that of a second reference model used for the DUT; or
the reference model is used only for the TE in a 2-sided AI/ML model framework.

Optionally, in this embodiment of this application, the reference model is obtained based on any one of the following:
a predefined model structure and a model parameter; or
a predefined model structure.

Optionally, in this embodiment of this application, the reference model is obtained based on any one of the following:
a predefined complete model structure and all model parameters;
a predefined complete model structure and partial model parameters;
a predefined partial model structure and partial parameters;
a predefined complete model structure; or
a predefined partial model structure.

Optionally, in this embodiment of this application, when the reference model is obtained based on the predefined model structure and the model parameter, the reference model includes at least one predefined model structure and at least one group of model parameters corresponding to each model structure; and
each model structure and one group of model parameters in the at least one group of model parameters corresponding to each model structure constitute one reference model, or every two matched model structures and respective corresponding groups of model parameters constitute one reference model pair.

Optionally, in this embodiment of this application, when the reference model is obtained based on the predefined model structure, the reference model includes at least one predefined model structure; and
each model structure corresponds to one reference model, or each model structure corresponds to one reference model pair.

Optionally, in this embodiment of this application, the reference model is obtained based on the predefined model structure, and the reference model meets that the reference model is used only for the DUT in the 1-sided AI/ML model framework; and
the processing module 702 is further configured to determine the reference model based on the predefined model structure and a model training dataset; or
the processing module 702 is further configured to determine the reference model based on the predefined model structure and a prestored model parameter.

Optionally, in this embodiment of this application, the reference model is obtained based on the predefined model structure, and the reference model meets that the reference model is used for the TE and the DUT in the 2-sided AI/ML model framework; and
the processing module 702 is further configured to determine a reference model sent by the TE as the reference model; or
the processing module 702 is further configured to determine the reference model based on the predefined model structure and a model parameter sent by the TE; or
the processing module 702 is further configured to perform joint training with the TE based on the predefined model structure and a reference training dataset, to obtain the reference model.

Optionally, in this embodiment of this application, the reference training dataset is a training dataset corresponding to the reference model.

Optionally, in this embodiment of this application, the reference model is obtained based on the predefined model structure, and
the processing module 702 is further configured to determine the reference model based on the predefined model structure and a reference training dataset corresponding to the reference model, where the reference model supports all wireless scenarios or configurations; or
the processing module 702 is further configured to process at least one reference model based on the predefined model structure and at least one group of reference training datasets corresponding to the reference model, where each reference model supports one wireless scenario or one configuration.

Optionally, in this embodiment of this application, the test result includes at least one of the following: an absolute amount of a test result of executing an AI functionality, an absolute amount of a test result of not executing an AI functionality, or a relative amount between a test result of executing an AI functionality and a test result of not executing an AI functionality.

Optionally, in this embodiment of this application, the test result includes at least one test result, and each test result is a test result corresponding to one wireless scenario or one configuration supported by the DUT; and
when a test result that does not meet a first preset condition exists in the at least one test result, device performance of the DUT fails the test; or
when a ratio of a first quantity to a second quantity is less than a first threshold, device performance of the DUT fails the test, where the first quantity is a quantity of test results that the device performance of the DUT passes the test in the at least one test result, and the second quantity is a quantity of the at least one test result; or
when performance information corresponding to the at least one test result does not meet a second preset condition, device performance of the DUT fails the test, where the performance information is used to represent device performance corresponding to the at least one test result.

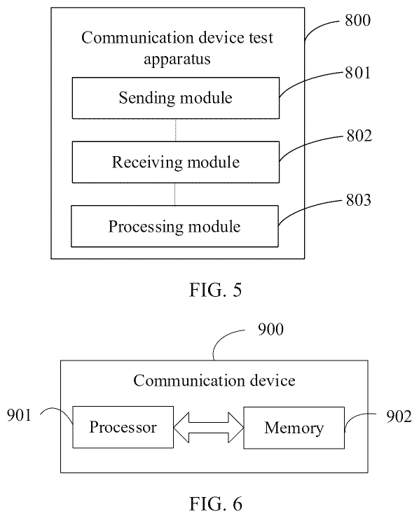

An embodiment of this application provides a communication device test apparatus. As shown in FIG. 5, the communication device test apparatus 800 includes a sending module 801, a receiving module 802, and a processing module 803. The sending module 801 is configured to send a first signal to a DUT, where the first signal is a signal corresponding to a first test case. The receiving module 802 is configured to receive a second signal sent by the DUT. The processing module 803 is configured to process the second signal to obtain a test result corresponding to the first test case, where the second signal includes at least one of the following: a signal obtained by processing the first signal by using a reference model with an artificial intelligence AI functionality, a signal obtained by performing non-AI functionality processing on the first signal, or a signal obtained by processing the first signal by using an AI model.

In the communication device test apparatus provided in this embodiment of this application, a reference model with an AI functionality is introduced as a reference for defining a unified performance requirement. A DUT may process, by using the reference model, a signal sent by the test apparatus, so that the test apparatus obtains a corresponding test result based on the signal processed by the DUT. In this way, this application provides a comprehensive test procedure for an AI/ML model-based communication device, thereby effectively overcoming the difficulty in applying a conventional test technology to the AI/ML model-based communication device.

Optionally, in this embodiment of this application, the reference model meets any one of the following:
the reference model is used only for the DUT in a 1-sided AI/ML model framework;
the reference model is used for the TE and the DUT in a 2-sided AI/ML model framework, and a structure of a first reference model used for the TE matches that of a second reference model used for the DUT; or
the reference model is used only for the TE in a 2-sided AI/ML model framework.

Optionally, in this embodiment of this application, the reference model is obtained based on any one of the following:
a predefined model structure and a model parameter; or
a predefined model structure.

Optionally, in this embodiment of this application, the reference model is obtained based on any one of the following:
a predefined complete model structure and all model parameters;
a predefined complete model structure and partial model parameters;
a predefined partial model structure and partial parameters;
a predefined complete model structure; or
a predefined partial model structure.

Optionally, in this embodiment of this application, when the reference model is obtained based on the predefined model structure and the model parameter, the reference model includes at least one predefined model structure and at least one group of model parameters corresponding to each model structure; and
each model structure and one group of model parameters in the at least one group of model parameters corresponding to each model structure constitute one reference model, or every two matched model structures and respective corresponding groups of model parameters constitute one reference model pair.

Optionally, in this embodiment of this application, when the reference model is obtained based on the predefined model structure, the reference model includes at least one predefined model structure; and
each model structure corresponds to one reference model, or each model structure corresponds to one reference model pair.

Optionally, in this embodiment of this application, the reference model is obtained based on the predefined model structure, and the reference model meets that the reference model is used only for the TE in the 2-sided AI/ML model framework; and
the processing module 803 is further configured to determine the reference model based on the predefined model structure and a model training dataset; or
the processing module 803 is further configured to determine the reference model based on the predefined model structure and a prestored model parameter.

Optionally, in this embodiment of this application, the reference model is obtained based on the predefined model structure, and the reference model meets that the reference model is used for the TE and the DUT in the 2-sided AI/ML model framework; and
the processing module 803 is further configured to determine a reference model sent by the DUT as the reference model; or
the processing module 803 is further configured to determine the reference model based on the predefined model structure and a model parameter sent by the DUT; or
the processing module 803 is further configured to perform joint training with the DUT based on the predefined model structure and a reference training dataset, to obtain the reference model.

Optionally, in this embodiment of this application, the reference training dataset is a training dataset corresponding to the reference model.

Optionally, in this embodiment of this application, the reference model is obtained based on the predefined model structure, and
the processing module 803 is further configured to determine the reference model based on the predefined model structure and a reference training dataset corresponding to the reference model, where the reference model supports all wireless scenarios or configurations; or
the processing module 803 is further configured to determine at least one reference model based on the predefined model structure and at least one group of reference training datasets corresponding to the reference model, where each reference model supports one wireless scenario or one configuration.

Optionally, in this embodiment of this application, the processing module 803 is further configured to load at least one group of test data, where the at least one group of test data is determined based on a wireless scenario or a configuration supported by the TE and target information, where the target information includes any one of the following: a stationary statistical channel model, a non-stationary statistical channel model, a field measurement result, or deterministic channel modeling; or the at least one group of test data is a predefined test dataset corresponding to a wireless scenario or a configuration.

Optionally, in this embodiment of this application, the test result includes a plurality of test results, and the plurality of test results include a result obtained after the TE dynamically switches a wireless scenario or a configuration supported by the TE, or a result obtained after the TE dynamically switches test data corresponding to a wireless scenario or a configuration supported by the TE.

Optionally, in this embodiment of this application, the plurality of test results include a result obtained after the TE dynamically switches a wireless scenario or a configuration or dynamically switches test data corresponding to a wireless scenario or a configuration within a preset test time; or
the plurality of test results include a result obtained after the TE dynamically switches a wireless scenario or a configuration or dynamically switches test data corresponding to a wireless scenario or a configuration in a plurality of preset wireless scenarios or configurations.

Optionally, in this embodiment of this application, the plurality of test results include results obtained by performing a test in all to-be-tested wireless scenarios or configurations supported by the TE; or
the plurality of test results include a result obtained by performing a test after the TE randomly switches a wireless scenario or a configuration; or
the plurality of test results include a result obtained by performing a test after the TE switches, based on a preset rule, a wireless scenario or a configuration supported by the TE.

Optionally, in this embodiment of this application, the test result includes at least one of the following: an absolute amount of a test result of executing an AI functionality, an absolute amount of a test result of not executing an AI functionality, or a relative amount between a test result of executing an AI functionality and a test result of not executing an AI functionality.

Optionally, in this embodiment of this application, the test result includes at least one test result, and each test result is a test result corresponding to one wireless scenario or one configuration supported by the DUT; and
when a test result that does not meet a first preset condition exists in the at least one test result, device performance of the DUT fails the test; or
when a ratio of a first quantity to a second quantity is less than a first threshold, device performance of the DUT fails the test, where the first quantity is a quantity of test results that the device performance of the DUT passes the test in the at least one test result, and the second quantity is a quantity of the at least one test result; or
when performance information corresponding to the at least one test result does not meet a second preset condition, device performance of the DUT fails the test, where the performance information is used to represent device performance corresponding to the at least one test result.

The communication device test apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a network attached storage (NAS), or the like. This is not limited in this embodiment of this application.

The communication device test apparatus provided in this embodiment of this application can implement the processes implemented in the method embodiment in FIG. 3, and achieve a same technical effect. To avoid repetition, details are not described herein again.

As shown in FIG. 6, an embodiment of this application further provides a communication device 900, including a processor 901 and a memory 902. The memory 902 stores a program or an instruction executable on the processor 901. For example, when the communication device 900 is a terminal, and when the program or the instruction is executed by the processor 901, the steps of the method embodiment on the DUT side or the TE side in the foregoing communication device test method embodiment are implemented, and a same technical effect can be achieved. When the communication device 900 is a network side device, and when the program or the instruction is executed by the processor 901, the steps of the method embodiment on the DUT side or the TE side in the foregoing communication device test method embodiment are implemented, and a same technical effect can be achieved. To avoid repetition, details are not described herein again.

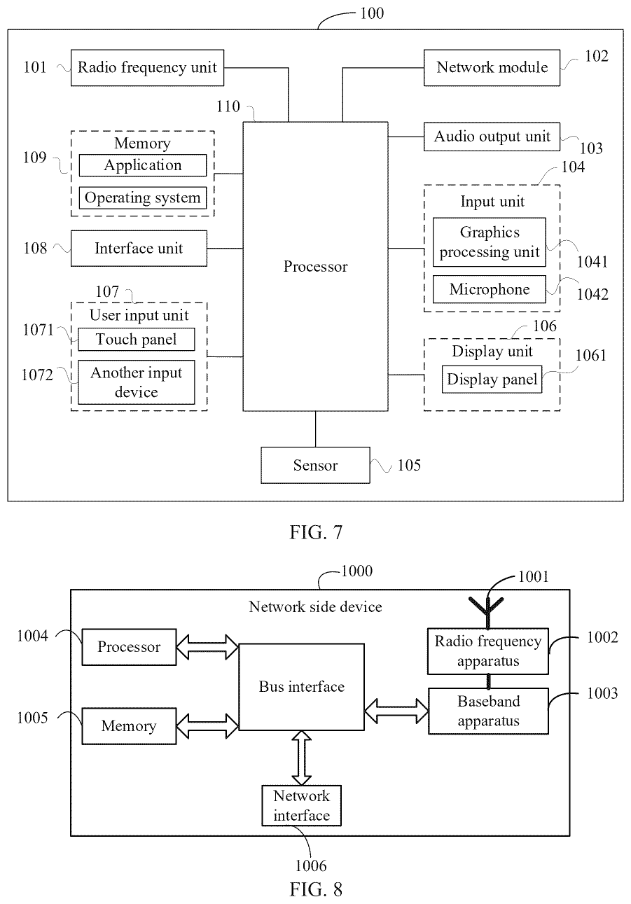

An embodiment of this application further provides a terminal, including a processor and a communication interface. The communication interface is coupled to the processor, and the processor is configured to run a program or an instruction to implement the steps of the method embodiment shown in FIG. 3. This terminal embodiment corresponds to the foregoing method embodiment on the DUT side or the TE side. Each implementation process and implementation of the foregoing method embodiment may be applicable to this terminal embodiment, and a same technical effect can be achieved. Optionally, FIG. 7 is a schematic structural diagram of hardware of a terminal according to an embodiment of this application.

The terminal 100 includes but is not limited to a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the terminal 100 may further include the power supply (for example, a battery) that supplies power to each component. The power supply may be logically connected to the processor 110 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 104 may include a graphics processing unit (GPU) 1041 and a microphone 1042, and the graphics processing unit 1041 processes image data of a still image or a video that is obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Usually, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may include a volatile memory or a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 109 in this embodiment of this application includes but is not limited to these memories and a memory of any other proper type.

The processor 110 may include one or more processing units. Optionally, an application processor and a modem processor are integrated into the processor 110. The application processor mainly processes an operating system, a user interface, an application, and the like. The modem processor mainly processes a wireless communication signal, for example, a baseband processor. It can be understood that, alternatively, the modem processor may not be integrated into the processor 110.

In an example, the radio frequency unit 101 is configured to receive a first signal sent by TE, where the first signal is a signal corresponding to a first test case. The processor 110 is configured to process the first signal. The radio frequency unit 101 is further configured to send a second signal to the TE, where the second signal includes at least one of the following: a signal obtained by processing the first signal by using a reference model with an AI functionality, a signal obtained by performing non-AI functionality processing on the first signal, or a signal obtained by processing the first signal by using an AI model; and the second signal is used to obtain a test result corresponding to the first test case.

Optionally, in this embodiment of this application, the reference model meets any one of the following:
the reference model is used only for the DUT in a 1-sided AI/ML model framework;
the reference model is used for the TE and the DUT in a 2-sided AI/ML model framework, and a structure of a first reference model used for the TE matches that of a second reference model used for the DUT; or
the reference model is used only for the TE in a 2-sided AI/ML model framework.

Optionally, in this embodiment of this application, the reference model is obtained based on any one of the following:
a predefined model structure and a model parameter; or
a predefined model structure.

Optionally, in this embodiment of this application, the reference model is obtained based on any one of the following:
a predefined complete model structure and all model parameters;
a predefined complete model structure and partial model parameters;
a predefined partial model structure and partial parameters;
a predefined complete model structure; or
a predefined partial model structure.

Optionally, in this embodiment of this application, when the reference model is obtained based on the predefined model structure and the model parameter, the reference model includes at least one predefined model structure and at least one group of model parameters corresponding to each model structure; and
each model structure and one group of model parameters in the at least one group of model parameters corresponding to each model structure constitute one reference model, or every two matched model structures and respective corresponding groups of model parameters constitute one reference model pair.

Optionally, in this embodiment of this application, when the reference model is obtained based on the predefined model structure, the reference model includes at least one predefined model structure; and
each model structure corresponds to one reference model, or each model structure corresponds to one reference model pair.

Optionally, in this embodiment of this application, the reference model is obtained based on the predefined model structure, and the reference model meets that the reference model is used only for the DUT in the 1-sided AI/ML model framework; and
the processor 110 is further configured to determine the reference model based on the predefined model structure and a model training dataset; or
the processor 110 is further configured to determine the reference model based on the predefined model structure and a prestored model parameter.

Optionally, in this embodiment of this application, the reference model is obtained based on the predefined model structure, and the reference model meets that the reference model is used for the TE and the DUT in the 2-sided AI/ML model framework; and
the processor 110 is further configured to determine a reference model sent by the TE as the reference model; or
the processor 110 is further configured to determine the reference model based on the predefined model structure and a model parameter sent by the TE; or
the processor 110 is further configured to perform joint training with the TE based on the predefined model structure and a reference training dataset, to obtain the reference model.

Optionally, in this embodiment of this application, the reference training dataset is a training dataset corresponding to the reference model.

Optionally, in this embodiment of this application, the reference model is obtained based on the predefined model structure, and
the processor 110 is further configured to determine the reference model based on the predefined model structure and a reference training dataset corresponding to the reference model, where the reference model supports all wireless scenarios or configurations; or
the processor 110 is further configured to process at least one reference model based on the predefined model structure and at least one group of reference training datasets corresponding to the reference model, where each reference model supports one wireless scenario or one configuration.

Optionally, in this embodiment of this application, the test result includes at least one of the following: an absolute amount of a test result of executing an AI functionality, an absolute amount of a test result of not executing an AI functionality, or a relative amount between a test result of executing an AI functionality and a test result of not executing an AI functionality.

Optionally, in this embodiment of this application, the test result includes at least one test result, and each test result is a test result corresponding to one wireless scenario or one configuration supported by the DUT; and
when a test result that does not meet a first preset condition exists in the at least one test result, device performance of the DUT fails the test; or
when a ratio of a first quantity to a second quantity is less than a first threshold, device performance of the DUT fails the test, where the first quantity is a quantity of test results that the device performance of the DUT passes the test in the at least one test result, and the second quantity is a quantity of the at least one test result; or
when performance information corresponding to the at least one test result does not meet a second preset condition, device performance of the DUT fails the test, where the performance information is used to represent device performance corresponding to the at least one test result.

It can be understood that, for an implementation process of each implementation mentioned in this embodiment, reference may be made to the related descriptions of the method embodiment on the DUT side, and a same or corresponding technical effect is achieved. To avoid repetition, details are not described herein again.

In another example, the radio frequency unit 101 is configured to send a first signal to a device under test DUT, where the first signal is a signal corresponding to a first test case. The radio frequency unit 101 is further configured to receive a second signal sent by the DUT. The processor 110 is configured to process the second signal to obtain a test result corresponding to the first test case, where the second signal includes at least one of the following: a signal obtained by processing the first signal by using a reference model with an artificial intelligence AI functionality, a signal obtained by performing non-AI functionality processing on the first signal, or a signal obtained by processing the first signal by using an AI model.

Optionally, in this embodiment of this application, the reference model meets any one of the following:
the reference model is used only for the DUT in a 1-sided AI/ML model framework;
the reference model is used for the TE and the DUT in a 2-sided AI/ML model framework, and a structure of a first reference model used for the TE matches that of a second reference model used for the DUT; or
the reference model is used only for the TE in a 2-sided AI/ML model framework.

Optionally, in this embodiment of this application, the reference model is obtained based on any one of the following:
a predefined model structure and a model parameter; or
a predefined model structure.

Optionally, in this embodiment of this application, the reference model is obtained based on any one of the following:
a predefined complete model structure and all model parameters;
a predefined complete model structure and partial model parameters;
a predefined partial model structure and partial parameters;
a predefined complete model structure; or
a predefined partial model structure.

Optionally, in this embodiment of this application, when the reference model is obtained based on the predefined model structure and the model parameter, the reference model includes at least one predefined model structure and at least one group of model parameters corresponding to each model structure; and
each model structure and one group of model parameters in the at least one group of model parameters corresponding to each model structure constitute one reference model, or every two matched model structures and respective corresponding groups of model parameters constitute one reference model pair.

Optionally, in this embodiment of this application, when the reference model is obtained based on the predefined model structure, the reference model includes at least one predefined model structure; and
each model structure corresponds to one reference model, or each model structure corresponds to one reference model pair.

Optionally, in this embodiment of this application, the reference model is obtained based on the predefined model structure, and the reference model meets that the reference model is used only for the TE in the 2-sided AI/ML model framework; and
the processor 110 is further configured to determine the reference model based on the predefined model structure and a model training dataset; or
the processor 110 is further configured to determine the reference model based on the predefined model structure and a prestored model parameter.

Optionally, in this embodiment of this application, the reference model is obtained based on the predefined model structure, and the reference model meets that the reference model is used for the TE and the DUT in the 2-sided AI/ML model framework; and
the processor 110 is further configured to determine a reference model sent by the DUT as the reference model; or
the processor 110 is further configured to determine the reference model based on the predefined model structure and a model parameter sent by the DUT; or
the processor 110 is further configured to perform joint training with the DUT based on the predefined model structure and a reference training dataset, to obtain the reference model.

Optionally, in this embodiment of this application, the reference training dataset is a training dataset corresponding to the reference model.

Optionally, in this embodiment of this application, the reference model is obtained based on the predefined model structure, and
the processor 110 is further configured to determine the reference model based on the predefined model structure and a reference training dataset corresponding to the reference model, where the reference model supports all wireless scenarios or configurations; or
the processor 110 is further configured to determine at least one reference model based on the predefined model structure and at least one group of reference training datasets corresponding to the reference model, where each reference model supports one wireless scenario or one configuration.

Optionally, in this embodiment of this application, the processor 110 is further configured to load at least one group of test data, where
the at least one group of test data is determined based on a wireless scenario or a configuration supported by the TE and target information, where the target information includes any one of the following: a stationary statistical channel model, a non-stationary statistical channel model, a field measurement result, or deterministic channel modeling; or the at least one group of test data is a predefined test dataset corresponding to a wireless scenario or a configuration.

Optionally, in this embodiment of this application, the test result includes a plurality of test results, and the plurality of test results include a result obtained after the TE dynamically switches a wireless scenario or a configuration supported by the TE, or a result obtained after the TE dynamically switches test data corresponding to a wireless scenario or a configuration supported by the TE.

Optionally, in this embodiment of this application, the plurality of test results include a result obtained after the TE dynamically switches a wireless scenario or a configuration or dynamically switches test data corresponding to a wireless scenario or a configuration within a preset test time; or
the plurality of test results include a result obtained after the TE dynamically switches a wireless scenario or a configuration or dynamically switches test data corresponding to a wireless scenario or a configuration in a plurality of preset wireless scenarios or configurations.

Optionally, in this embodiment of this application, the plurality of test results include results obtained by performing a test in all to-be-tested wireless scenarios or configurations supported by the TE; or
the plurality of test results include a result obtained by performing a test after the TE randomly switches a wireless scenario or a configuration; or
the plurality of test results include a result obtained by performing a test after the TE switches, based on a preset rule, a wireless scenario or a configuration supported by the TE.

Optionally, in this embodiment of this application, the test result includes at least one of the following: an absolute amount of a test result of executing an AI functionality, an absolute amount of a test result of not executing an AI functionality, or a relative amount between a test result of executing an AI functionality and a test result of not executing an AI functionality.

Optionally, in this embodiment of this application, the test result includes at least one test result, and each test result is a test result corresponding to one wireless scenario or one configuration supported by the DUT; and
when a test result that does not meet a first preset condition exists in the at least one test result, device performance of the DUT fails the test; or
when a ratio of a first quantity to a second quantity is less than a first threshold, device performance of the DUT fails the test, where the first quantity is a quantity of test results that the device performance of the DUT passes the test in the at least one test result, and the second quantity is a quantity of the at least one test result; or
when performance information corresponding to the at least one test result does not meet a second preset condition, device performance of the DUT fails the test, where the performance information is used to represent device performance corresponding to the at least one test result.

It can be understood that, for an implementation process of each implementation mentioned in this embodiment, reference may be made to the related descriptions of the method embodiment on the TE side, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 3. This network side device embodiment corresponds to the foregoing method embodiment on the DUT side or the TE side. Each implementation process and implementation of the foregoing method embodiment may be applicable to this network side device embodiment, and a same technical effect can be achieved.

Optionally, an embodiment of this application further provides a network side device. As shown in FIG. 8, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information by using the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information by using the antenna 1001.

In the foregoing embodiment, the method performed by the network side device may be implemented in the baseband apparatus 1003. The baseband apparatus 1003 includes a baseband processor.

The baseband apparatus 1003 may include, for example, at least one baseband board, where a plurality of chips are disposed on the baseband board. As shown in FIG. 8, one chip, for example, the baseband processor, is connected to the memory 1005 through a bus interface, to invoke a program in the memory 1005 to perform the operations of the network side device shown in the foregoing method embodiment.

The network side device may further include a network interface 1006, and the interface is, for example, a common public radio interface (CPRI).

Optionally, the network side device 1000 in this embodiment of this application further includes an instruction or a program that is stored in the memory 1005 and executable on the processor 1004. The processor 1004 invokes the instruction or the program in the memory 1005 to perform the method performed by the modules shown in FIG. 4 or FIG. 5, and a same technical effect is achieved. To avoid repetition, details are not described herein again.

An embodiment of this application further provides a non-transitory readable storage medium. The non-transitory readable storage medium stores a program or an instruction, and when the program or the instruction is executed by a processor, the processes of the foregoing communication device test method embodiment are implemented, and a same technical effect can be achieved. To avoid repetition, details are not described herein again.

The processor is a processor in the terminal in the foregoing embodiment. The non-transitory readable storage medium includes a non-transitory computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing communication device test method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a non-transitory storage medium, and the program/program product is executed by at least one processor to implement the processes of the foregoing communication device test method embodiment, and a same technical effect can be achieved. To avoid repetition, details are not described herein again.

An embodiment of this application further provides a communication system, including a terminal and a network side device. The terminal may be configured to perform the steps of the foregoing communication device test method, and the network side device may be configured to perform the steps of the foregoing communication device test method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a ...” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the foregoing method embodiment may be implemented by computer software product in addition to a necessary general hardware platform or by hardware. The computer software product is stored in a storage medium (for example, a ROM, a RAM, a magnetic disk, or an optical disc) and includes several instructions, so that the terminal or the network side device executes the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms of implementations without departing from the purpose of this application and the protection scope of the claims, all of which fall within the protection of this application.

What is claimed is:

1. A communication device test method, comprising:
receiving, by a device under test (DUT), a first signal sent by test equipment (TE), wherein the first signal is a signal corresponding to a first test case; and
processing, by the DUT, the first signal, and sending a second signal to the TE, wherein
the second signal comprises at least one of the following: a signal obtained by processing the first signal by using a reference model with an artificial intelligence (AI) functionality, a signal obtained by performing non-AI functionality processing on the first signal, or a signal obtained by processing the first signal by using an AI model; and the second signal is used to obtain a test result corresponding to the first test case.

2. The method according to claim 1, wherein the reference model meets any one of the following:
the reference model is used only for the DUT in a 1-sided artificial intelligence/machine learning (AI/ML) model framework;
the reference model is used for the TE and the DUT in a 2-sided AI/ML model framework, and a structure of a first reference model used for the TE matches a structure of a second reference model used for the DUT; or
the reference model is used only for the TE in the 2-sided AI/ML model framework.

3. The method according to claim 1, wherein the reference model is obtained based on any one of the following:
a predefined model structure and a model parameter; or
a predefined model structure.

4. The method according to claim 1, wherein the reference model is obtained based on any one of the following:
a predefined complete model structure and all model parameters;
a predefined complete model structure and partial model parameters;
a predefined partial model structure and partial parameters;
a predefined complete model structure; or
a predefined partial model structure.

5. The method according to claim 3, wherein when the reference model is obtained based on the predefined model structure and the model parameter, the reference model comprises at least one predefined model structure and at least one group of model parameters corresponding to each model structure; and
each model structure and one group of model parameters in the at least one group of model parameters corresponding to each model structure constitute one reference model, or every two matched model structures and respective corresponding groups of model parameters constitute one reference model pair;
or,
when the reference model is obtained based on the predefined model structure, the reference model comprises at least one predefined model structure; and
each model structure corresponds to one reference model, or each model structure corresponds to one reference model pair.

6. The method according to claim 3, wherein the reference model is obtained based on the predefined model structure, and the reference model meets that the reference model is used only for the DUT in the 1-sided artificial intelligence/machine learning (AI/ML) model framework; and
the method further comprises any one of the following:
determining, by the DUT, the reference model based on the predefined model structure and a model training dataset; or
determining, by the DUT, the reference model based on the predefined model structure and a prestored model parameter;
or,
the reference model is obtained based on the predefined model structure, and the reference model meets that the reference model is used for the TE and the DUT in the 2-sided AI/ML model framework; and
the method further comprises any one of the following:
determining, by the DUT, a reference model sent by the TE as the reference model;
determining, by the DUT, the reference model based on the predefined model structure and a model parameter sent by the TE; or
performing, by the DUT, joint training with the TE based on the predefined model structure and a reference training dataset, to obtain the reference model; wherein the reference training dataset is a training dataset corresponding to the reference model.

7. The method according to claim 3, wherein the reference model is obtained based on the predefined model structure, and the method further comprises:
determining, by the DUT, the reference model based on the predefined model structure and a reference training dataset corresponding to the reference model, wherein the reference model supports all wireless scenarios or configurations; or
determining, by the DUT, at least one reference model based on the predefined model structure and at least one group of reference training datasets corresponding to the reference model, wherein each reference model supports one wireless scenario or one configuration.

8. The method according to claim 1, wherein the test result comprises at least one of the following: an absolute amount of a test result of executing an AI functionality, an absolute amount of a test result of not executing an AI functionality, or a relative amount between a test result of executing an AI functionality and a test result of not executing an AI functionality.

9. The method according to claim 1, wherein the test result comprises at least one test result, and each test result is a test result corresponding to one wireless scenario or one configuration supported by the DUT; and
when a test result that does not meet a first preset condition exists in the at least one test result, device performance of the DUT fails the test; or
when a ratio of a first quantity to a second quantity is less than a first threshold, device performance of the DUT fails the test, wherein the first quantity is a quantity of test results that the device performance of the DUT passes the test in the at least one test result, and the second quantity is a quantity of the at least one test result; or
when performance information corresponding to the at least one test result does not meet a second preset condition, device performance of the DUT fails the test, wherein the performance information is used to represent device performance corresponding to the at least one test result.

10. A communication device test method, comprising:
sending, by test equipment (TE), a first signal to a device under test (DUT), wherein the first signal is a signal corresponding to a first test case; and
receiving, by the TE, a second signal sent by the DUT, and processing the second signal to obtain a test result corresponding to the first test case, wherein
the second signal comprises at least one of the following: a signal obtained by processing the first signal by using a reference model with an artificial intelligence (AI) functionality, a signal obtained by performing non-AI functionality processing on the first signal, or a signal obtained by processing the first signal by using an AI model.

11. The method according to claim 10, wherein the reference model is obtained based on any one of the following:
a predefined model structure and a model parameter; or
a predefined model structure.

12. The method according to claim 11, wherein the reference model is obtained based on the predefined model structure, and the reference model meets that the reference model is used only for the TE in the 2-sided artificial intelligence/machine learning (AI/ML) model framework; and
the method further comprises any one of the following:
determining, by the TE, the reference model based on the predefined model structure and a model training dataset; or
determining, by the TE, the reference model based on the predefined model structure and a prestored model parameter;
or,
the reference model is obtained based on the predefined model structure, and the reference model meets that the reference model is used for the TE and the DUT in the 2-sided AI/ML model framework; and
the method further comprises any one of the following:
determining, by the TE, a reference model sent by the DUT as the reference model;
determining, by the TE, the reference model based on the predefined model structure and a model parameter sent by the DUT; or
performing, by the TE, joint training with the DUT based on the predefined model structure and a reference training dataset, to obtain the reference model;
wherein the reference training dataset is a training dataset corresponding to the reference model.

13. The method according to claim 11, wherein the reference model is obtained based on the predefined model structure, and the method further comprises:
determining, by the TE, the reference model based on the predefined model structure and a reference training dataset corresponding to the reference model, wherein the reference model supports all wireless scenarios or configurations; or
determining, by the TE, at least one reference model based on the predefined model structure and at least one group of reference training datasets corresponding to the reference model, wherein each reference model supports one wireless scenario or one configuration.

14. The method according to claim 10, wherein the method further comprises:
loading, by the TE, at least one group of test data, wherein
the at least one group of test data is determined based on a wireless scenario or a configuration supported by the TE and target information, wherein the target information comprises any one of the following: a stationary statistical channel model, a non-stationary statistical channel model, a field measurement result, or deterministic channel modeling; or the at least one group of test data is a predefined test dataset corresponding to a wireless scenario or a configuration.

15. The method according to claim 10, wherein the test result comprises a plurality of test results, and the plurality of test results comprise a result obtained after the TE dynamically switches a wireless scenario or a configuration supported by the TE, or a result obtained after the TE dynamically switches test data corresponding to a wireless scenario or a configuration supported by the TE.

16. The method according to claim 15, wherein the plurality of test results comprise a result obtained after the TE dynamically switches a wireless scenario or a configuration or dynamically switches test data corresponding to a wireless scenario or a configuration within a preset test time; or
the plurality of test results comprise a result obtained after the TE dynamically switches a wireless scenario or a configuration or dynamically switches test data corresponding to a wireless scenario or a configuration in a plurality of preset wireless scenarios or configurations;
or,
the plurality of test results comprise results obtained by performing a test in all to-be-tested wireless scenarios or configurations supported by the TE; or
the plurality of test results comprise a result obtained by performing a test after the TE randomly switches a wireless scenario or a configuration; or
the plurality of test results comprise a result obtained by performing a test after the TE switches, based on a preset rule, a wireless scenario or a configuration supported by the TE.

17. A terminal, comprising a processor and a memory, wherein the memory stores a program or an instruction executable on the processor, and the program or the instruction, when executed by the processor, causes the terminal to perform:
receiving a first signal sent by test equipment (TE), wherein the first signal is a signal corresponding to a first test case; and
processing the first signal, and sending a second signal to the TE, wherein
the second signal comprises at least one of the following: a signal obtained by processing the first signal by using a reference model with an artificial intelligence (AI) functionality, a signal obtained by performing non-AI functionality processing on the first signal, or a signal obtained by processing the first signal by using an AI model; and the second signal is used to obtain a test result corresponding to the first test case.

18. A terminal, comprising a processor and a memory, wherein the memory stores a program or an instruction executable on the processor, and when the program or the instruction is executed by the processor, the steps of the communication device test method according to claim 10 are implemented.

19. A network side device, comprising a processor and a memory, wherein the memory stores a program or an instruction executable on the processor, and when the program or the instruction is executed by the processor, the steps of the communication device test method according to claim 1 are implemented.

20. A network side device, comprising a processor and a memory, wherein the memory stores a program or an instruction executable on the processor, and when the program or the instruction is executed by the processor, the steps of the communication device test method according to claim 10 are implemented.
